(19) United States
(12) Patent Application Publication
(10) Pub. No.: US 2023/0073324 A1
(43) Pub. Date: Mar. 9, 2023

(54) SYSTEMS AND METHODS FOR PERFORMING OPTICAL IMAGING USING DUO-SPOT POINT SPREAD FUNCTIONS

(71) Applicant: Washington University, St. Louis, MO (US)

(72) Inventors: Matthew Lew, St. Louis, MO (US); Tingting Wu, St. Louis, MO (US); Tianben Ding, St. Louis, MO (US)

(73) Assignee: Washington University, St. Louis, MO (US)

(21) Appl. No.: 17/800,171

(22) PCT Filed: Feb. 16, 2021
(86) PCT No.: PCT/US21/18235

§ 371 Date: Aug. 16, 2022

Related U.S. Application Data
(60) Provisional application No. 62/977,407, filed on Feb. 16, 2020.

(51) Int. Cl. G01N 21/64

(52) U.S. Cl. CPC G01N 21/6458

(57) ABSTRACT

Systems, devices and methods for determining an orientation and a rotational mobility of the single point emitter using a duo-spot point spread function (PSF) phase mask are disclosed. The duo-spot PSF phase mask includes at least three partitions, in which each partition includes a phase delay ramp aligned along one of two phase delay axes. Each phase delay ramp includes a gradient of phase delays. Each partition includes a subset of a total area of the phase mask and the two phase delay axes are oriented in different directions. The duo-spot PSF phase mask is configured to produce a duo-spot PSF that includes two light spots. The relative brightness of the two spots encodes an orientation and a rotational mobility of the single point emitter.

### CROSS-REFERENCE TO RELATED APPLICATIONS

The application claims the benefit of priority to U.S. Provisional Application No. 62/977,408 filed on Feb. 16, 2020, the contents of which are incorporated by reference herein in their entirety.

### STATEMENT REGARDING FEDERALLY SPONSORED RESEARCH OR DEVELOPMENT

This invention was made with government support under 1653777 awarded by the National Science Foundation and GM124858 awarded by the National Institutes of Health. The government has certain rights in the invention.

### FIELD OF THE DISCLOSURE

The present disclosure generally relates to microscopy systems and methods, and in particular the present disclosure relates to microscopy systems and methods for quantifying the position and orientation of dipole emitters in low signal-to-noise conditions.

### BACKGROUND OF THE DISCLOSURE

In soft matter, thermal energy causes molecules to continuously translate and rotate, even in crowded environments, impacting the spatial organization and function of most molecular assemblies, such as lipid membranes. At the bulk level, these dynamics are typically measured using absorption, fluorescence, nuclear magnetic resonance, or Raman spectroscopies. Directly measuring the orientation and spatial organization of large collections of single molecules remains elusive, particularly with high sampling densities (>900 molecules/μm²) and nanoscale resolution.

Tracking a molecule's 3D position and orientation (and associated translational and rotational motions) within soft matter is critical for understanding the intrinsically heterogeneous and complex interactions of its various components across length scales, including associations of surrounding molecules, functional groups, ions, and charges. In living cells, the local organization of and interfaces between many biomolecular assemblies, such as lipid membranes, chromosomes, and cytoskeletal proteins, ensure the proper functioning of all cellular compartments. The orientation and organization of molecules also significantly impact the nanoscale morphology of supramolecular structures, the physical and mechanical properties of polymers, and the carrier mobility in organic solar cells and organic light-emitting diodes.

Molecular orientations are commonly inferred from measuring an order parameter determined via X-ray diffraction, infrared spectroscopy, NMR, Raman spectroscopy, sum frequency generation spectroscopy, and fluorescence microscopy. However, the order parameter is an ensemble average taken over many molecules and cannot unambiguously determine the 3D orientation of a single molecule (SM). Spectrally-resolved SM localization microscopy (SMLM) has been developed to map the local polarity or hydrophobicity of protein aggregates and subcellular structures, and fluorescence lifetime imaging has been applied to recognize sub-resolution lipid domains in the plasma membrane. However, these approaches require specific environment-sensitive fluorescent probes (e.g., Nile red, Laurdan, and 3-hydroxyflavone derivatives) whose excited electronic states are sensitive to local environment, resulting in detectable changes in fluorescence spectra (intensities) or lifetimes. Alternatively, we know the orientation and motion of any fluorescent probe are directly influenced by its local environment, regardless of its solvatochromicity or lifetime. Therefore, imaging the 3D orientation and wobble of SMs, which we term as “orientation spectra” in this work, offers an alternative and widely applicable strategy for sensing molecular interactions within a sample of interest using any SMLM-compatible fluorescent dyes. Orientation spectra, which are characteristics of the molecules, may be inferred from angular emission spectra and polarization spectra, which are characteristics of the detected photons. We propose that nanoscale imaging of SM orientation spectra may provide direct insight into the spatial organization of molecular assemblies, macromolecules, and subcellular structures, which is helpful for constructing mechanistic models of biological systems.

Other objects and features will be in part apparent and in part pointed out hereinafter.

### SUMMARY OF THE DISCLOSURE

In one aspect, a phase mask for a point spread function imaging system is disclosed that includes at least three partitions. Each partition includes a phase delay ramp aligned along one of two phase delay axes. Each phase delay ramp includes a gradient of phase delays. Each partition includes a subset of a total area of the phase mask and the two phase delay axes are oriented in different directions. In some aspects, the phase mask is configured to produce a duo-spot point-spread function comprising two light spots. In some aspects, each light spot of the two light spots corresponds to one phase delay axis of the two phase delay axes. In some aspects, the phase mask is configured to produce the duo-spot point-spread function in response to photons produced by a single point emitter. In some aspects, a relative brightness of each spot of the duo-spot point spread function encodes an orientation and a rotational mobility of the single point emitter. In some aspects, the two phase delay axes are oriented parallel and in opposite directions to one another. In some aspects, the phase mask further includes a phase-only spatial light modulator. In some aspects, the shape of each partition is configured to separate one basis image from a plurality of base images consisting of Bₓₓ, B_{yy}, B_{zz}, B_{xy}, B_{yz}, and B_{xz}, the one basis image selected from Bₓₓ, B_{yy}, and B_{zz} within an x-polarized image channel and a y-polarized image channel of the point spread function imaging system. In some aspects, the shape of each partition is configured to separate positive and negative energies associated with one basis image from a plurality of base images consisting of Bₓₓ, B_{yy}, B_{zz}, B_{xy}, B_{yz}, and B_{xz} within an x-polarized image channel and a y-polarized image channel of the point spread function imaging system, wherein the one basis image is selected from B_{xy}, B_{yz}, and B_{xz}.

In another aspect, a point spread function imaging system is disclosed that includes a source arranged and configured to output an excitation beam that is directed to a sample containing at least one light emitter that emits a dipole or dipole-like radiation pattern when illuminated by the excitation beam; at least one sensor arranged and configured to capture at least one image of at least a portion of a radiation pattern emitted by the at least one emitter in response to impingement by the excitation beam; and a phase mask positioned between the at least one emitter and the at least one sensor. The phase mask is configured to produce a duo-spot point spread function in response to photons received from the at least one emitter. The duo-spot point spread function is received by the at least one sensor. In some aspects, the phase mask includes at least three partitions, each partition includes a phase delay ramp aligned along one of two phase delay axes, each phase delay ramp includes a gradient of phase delays, each partition includes a subset of a total area of the phase mask, and the two phase delay axes are oriented in different directions. In some aspects, the phase mask is configured to produce a duo-spot point-spread function comprising two light spots. In some aspects, each light spot of the two light spots corresponds to one phase delay axis of the two phase delay axes. In some aspects, the phase mask is configured to produce the duo-spot point-spread function in response to photons produced by a single point emitter. In some aspects, a relative brightness of each spot of the duo-spot point spread function encodes an orientation and a rotational mobility of the single point emitter. In some aspects, the two phase delay axes are oriented parallel and in opposite directions to one another. In some aspects, the phase mask further includes a phase-only spatial light modulator. In some aspects, the shape of each partition is configured to separate one basis image from a plurality of base images consisting of Bₓₓ, B_{yy}, B_{zz}, B_{xy}, B_{yz}, and B_{xz}, the one basis image selected from Bₓₓ, B_{yy}, and B_{zz} within an x-polarized image channel and a y-polarized image channel of the point spread function imaging system. In some aspects, the shape of each partition is configured to separate positive and negative energies associated with one basis image from a plurality of base images consisting of Bₓₓ, B_{yy}, B_{zz}, B_{xy}, B_{yz}, and B_{xz} within an x-polarized image channel and a y-polarized image channel of the point spread function imaging system, wherein the one basis image is selected from B_{xy}, B_{yz}, and B_{xz}. In some aspects, the system also includes a computing device operatively connected to the sensor. The computing device is configured to estimate the dependent orientation and the rotational mobility of the single molecule emitter encoded by the spots of the duo-spot point-spread function using a method selected from a basis inversion method, a maximum likelihood estimation method, and any combination thereof.

In another aspect, a method for estimating an orientation and a rotational mobility of a single-molecule emitter is disclosed that includes: receiving a plurality of photons emitted by the single-molecule emitter to produce a back focal plane intensity distribution; modifying the back focal plane intensity distribution using a phase mask to produce an image plane intensity distribution, in which the image plane intensity distribution includes a duo-spot point spread function; and estimating the orientation and rotational mobility of the dipole-like emitter based on a relative brightness of the two light spots of the duo-spot point spread function. The duo-spot point spread function includes two light spots. In some aspects, the phase mask includes at least three partitions, each partition including a phase delay ramp aligned along one of two phase delay axes, each phase delay ramp including a gradient of phase delays. Each partition includes a subset of a total area of the phase mask and the two phase delay axes are oriented in different directions. In some aspects, the orientation and the rotational mobility of the single-molecule emitter are estimated using a method selected from a basis inversion method, a maximum likelihood estimation method, and any combination thereof. In some aspects, the method further includes separating the back focal plane intensity distribution into a first channel that includes a first light polarization and a second channel that includes a second light polarization and modifying the first channel and the second channel independently using the phase mask to produce a first and second channel of the image plane intensity distribution.

### DESCRIPTION OF THE DRAWINGS

Those of skill in the art will understand that the drawings, described below, are for illustrative purposes only. The drawings are not intended to limit the scope of the present teachings in any way.

FIG. TA is a schematic diagram of the 3D orientation and wobble of a single dipole, parameterized by polar angle (θ), azimuthal angle (ϕ), and wobble solid angle (Ω, modeling rotational diffusion within a cone).

FIG. 1B is a schematic diagram of the orientation and wobble of DiI and MC540 within a supported lipid bilayer.

FIG. 1C is a representative image of DiI in x-polarized and y-polarized fluorescence channels using the Tri-spot point spread function (PSF). Yellow crosses represent the recovered position of each molecule. Insets: Magnified images of a single molecule.

FIG. 1D is a representative image of MC540 in x-polarized and y-polarized fluorescence channels using the Tri-spot point spread function (PSF). Yellow crosses represent the recovered position of each molecule. Insets: Magnified images of a single molecule.

FIG. 1E is a graph summarizing orientation (polar angle θ) and wobble (solid angle Ω) measurements of single DiI molecules. The thick solid lines in the scatter plots show the first to third quartile range of measured polar and solid angles; their intersection indicates the median values. The ends of dash lines indicate the 9th and 91st percentiles. The red triangle indicates the orientation spectra of the molecule shown in the insets of FIG. 1C. The maximum y-axis limit is set as the highest measurable solid angle for detected signal and background photons in experiments. Scale bar: 2 μm.

FIG. 1F is a graph summarizing orientation (polar angle θ) and wobble (solid angle Ω) measurements of single MC540 molecules. The thick solid lines in the scatter plots show the first to third quartile range of measured polar and solid angles; their intersection indicates the median values. The ends of dash lines indicate the 9th and 91st percentiles. The red triangle indicates the orientation spectra of the molecule shown in the insets of FIG. 1D. The maximum y-axis limit is set as the highest measurable solid angle for detected signal and background photons in experiments. Scale bar: 2 μm.

FIG. 1G is a graph summarizing orientation (polar angle θ) and wobble (solid angle Ω) of Nile red in DPPC with different cholesterol levels. Insets: median polar angle and solid angle over different lipid conditions. The maximum y-axis limit is set as the highest measurable solid angle for detected signal and background photons in experiments. Scale bar: 2 μm.

FIG. 1H is a graph summarizing orientation (polar angle θ) and wobble (solid angle Ω) of Nile red in DOPC, POPC, DPPC with various acyl chain structures. Insets: median polar angle and solid angle over different lipid conditions. The maximum y-axis limit is set as the highest measurable solid angle for detected signal and background photons in experiments. Scale bar: 2 μm.

FIG. 2A contains a series of SMOLM images of Lo and Ld domains within a mixed SLB including a conventional MC540 SMLM image (left), and Nile red (NR) SMOLM images depicting solid angle (Ω, center left)), polar angle (θ, center right), and combined phase index of a ternary lipid mixture of DOPC/DPPC/chol (right). Inset: SMLM (colormap limits shown in parentheses) and SMOLM images containing the same SM localization density of 400 molecules/μm². Scale bar: 2 μm. Bin size: 28 nm in SMLM, 40 nm in SMOLM.

FIG. 2B contains corresponding magnified views of the SMOLM images of FIG. 2A. Scale bar: 500 nm. Bin size: 28 nm in SMLM, 40 nm in SMOLM.

FIG. 2C contains histograms and median±std of solid angles (left) and polar angles (right) of Nile red in Lo and Ld domains from FIG. 2B. Gray pixels in SMOLM images represent bins with zero localizations.

FIG. 2D contains cross-sectional profiles of SMLM localizations, solid angles (Ω), polar angles (θ), and phase indices along the green lines (1,2) in FIG. 2B. Gray shaded regions represent Lo domains. Bin size: 28 nm in SMLM, 40 nm in SMOLM.

FIG. 3A contains conventional MC540 SMLM images and schematics of a lipid mixture of DOPC/SPM/chol before (t₀, left) and after (t₃, right) three treatments of SMase. Scale bar: 2 μm. Bin size: 28 nm.

FIG. 3B contains a series of SMOLM images (solid angle (Ω), polar angle (θ), and phase index) of Nile red before (t₀, left) and after SMase treatments of 16 mU/mL (t₁, center left), 50 mU/mL (t₂, center right), and 250 mU/mL (t₃, right). Scale bar: 2 μm. Bin size: 45 nm.

FIG. 3C contains corresponding magnified views of the SMOLM phase-index maps from the red boxed regions in FIG. 3B at to (left), t₂ (left center), and t₃ (right center), as well as a lipid composition map at t₃ (right), indicating compositional changes within the Lₒ domain with minor changes in size and shape during SMase treatment. The solid and dotted black lines represent the Lₒ domain boundary before and after SMase treatment, respectively. Scale bar: 200 nm. Bin size: 45 nm.

FIG. 3D contains histograms of solid angle (left), polar angle (center), and phase index (right) of the single Lₒ domain in FIG. 3C before (t₀) and after (t₃) SMase treatment.

FIG. 3E contains a magnified view of the SMOLM phase-index maps from the orange boxed regions in FIGS. 3A and 3B at to (left) and t₃ (center), as well as a lipid composition map at t₃ (right) indicating a newly generated Lₒ domain by SMase. The solid and dotted black lines represent the Lₒ domain boundary before and after SMase treatment, respectively. Scale bar: 200 nm. Bin size: 45 nm.

FIG. 4A is a graph summarizing the orientation (polar angle θ) and wobble (solid angle Ω) of Nile red in DPPC after the treatment of MβCD-chol with different doses and durations. The thick solid lines in the scatter plots show the first to third quartile range of measured polar and solid angles; their intersection indicates the median values. The ends of dash lines indicate the 9th and 91st percentiles.

FIG. 4B is a graph summarizing the orientation and wobble of Nile red after additional treatment of higher dose of MβCD-chol, implying the maximum ordering effect that chol can impart upon Nile red, which most likely corresponds to the maximum equilibrium solubility of cholesterol in DPPC. The thick solid lines in the scatter plots show the first to third quartile range of measured polar and solid angles; their intersection indicates the median values. The ends of dash lines indicate the 9th and 91st percentiles.

FIG. 4C is a graph summarizing the orientation and wobble of Nile red in DPPC+40% chol with different levels of melatonin. Inset: changes in median polar angle and solid angle for various melatonin concentrations. The thick solid lines in the scatter plots show the first to third quartile range of measured polar and solid angles; their intersection indicates the median values. The ends of dash lines indicate the 9th and 91st percentiles.

FIG. 5A is a graph summarizing orientation (polar angle θ) and wobble (solid angle Ω) of Nile red in POPC SLBs with various concentrations of cholesterol.

FIG. 5B is a graph summarizing orientation (polar angle θ) and wobble (solid angle Ω) of Nile red in DOPC SLBs with various concentrations of cholesterol.

FIG. 5C is a graph summarizing orientation (polar angle θ) and wobble (solid angle Ω) of Nile red in SPM SLBs with various concentrations of cholesterol.

FIG. 6A is a diagram of the chemical structures of Nile blue and Nile red.

FIG. 6B is a scatter graph summarizing orientation (polar angle θ) and wobble (solid angle Ω) of Nile blue in DPPC with 0 and 40% chol.

FIG. 6C is a scatter graph summarizing orientation (polar angle θ) and wobble (solid angle Ω) of Nile blue in DOPC with 0 and 40% chol.

FIG. 7A is a conventional MC540 SMLM image (9×10³ mol./μm² localization density) of a ternary lipid mixture of DOPC/DPPC/chol showing Lₒ(dark) and La (bright) domains. Insets: Lₒ domain maps (blue, binary images) constructed from MC540 SMLM images with corresponding localization densities. Bin size: 45 nm

FIG. 7B contains MC540 SMLM images reconstructed from a subset of the raw data with various localization densities: 50 (top), 100 (upper center), 400 (lower center), and 900 mol./μm²(lower). Insets: Lₒ domain maps (blue, binary images) constructed from MC540 SMLM images with corresponding localization densities. Bin size: 45 nm

FIG. 7C contains Nile red SMOLM images reconstructed from a subset of the raw data with various localization densities: 50 (top), 100 (upper center), 400 (lower center), and 900 mol./μm²(lower). Insets: Lₒ domain maps (blue, binary images) constructed from Nile red SMOLM images with corresponding localization densities. Scale bar: 2 μm. Bin size: 45 nm

FIG. 7D is a graph summarizing Root Mean Squared Error (RMSE) between the ground truth Lₒ domain map in the inset of FIG. 7A and SMLM or SMOLM Lₒ domain maps in insets of FIGS. 7B and 7C, respectively.

FIG. 8A contains a series of SMOLM imaging using MC540 of a mixed DOPC/DPPC SLB (1:1, molar ratio), including a conventional SMLM image (left) and SMOLM images of solid angle (Ω) (center left), polar angle (θ) (center right), and phase index using MC540.

FIG. 8B is a scatter plot of orientation (polar angle θ) and wobble (solid angle Ω) of MC540 in a DOPC (liquid phase) and a DPPC (gel phase) SLB.

FIG. 8C contains graphs summarizing cross-sectional profiles of SMLM localizations, solid angles (Ω), polar angles (θ), and phase indices along transect 1 of FIG. 8A (left) and along transect 2 of FIG. 8A (right); gray shaded regions represent Lo domains.

FIG. 8D contains histograms of solid angles (left) and polar angles (right) along transect 1 of FIG. 8A.

FIG. 8E contains a series of SMOLM imaging using Nile red of a mixed DOPC/DPPC SLB (1:1, molar ratio), including a conventional SMLM image (left) and SMOLM images of solid angle (Ω) (center left), polar angle (θ) (center right), and phase index using MC540.

FIG. 8F is a scatter plot of orientation (polar angle θ) and wobble (solid angle Ω) of Nile red in a DOPC (liquid phase) and a DPPC (gel phase) SLB.

FIG. 8G contains graphs summarizing cross-sectional profiles of SMLM localizations, solid angles (Ω), polar angles (θ), and phase indices along transect 1 of FIG. 8E (left) and along transect 2 of FIG. 8E (right); gray shaded regions represent Lo domains.

FIG. 8H contains histograms of solid angles (left) and polar angles (right) along transect 1 of FIG. 8A.

FIG. 9A is a scatter plot summarizing orientation (polar angle θ) and wobble (solid angle Ω) of MC540 in DOPC (La phase) and DPPC+chol (Lₒ phase) SLBs.

FIG. 9B is a scatter plot summarizing orientation (polar angle θ) and wobble (solid angle Ω) of Nile red in DOPC (La phase) and DPPC+chol (Lₒ phase) SLBs.

FIG. 10A contains basis images at the back focal plane corresponding to orientational second-moment components [symbol] μ_{y}² [symbol] (left) and [symbol] μ_{z}² [symbol] (right) in the y-polarized emission channel. Color bar: normalized intensity.

FIG. 10B is an illustration of a duo-spot phase mask; color bar denotes phase (rad).

FIG. 10C contains a simulated duo-spot PSF image for an isotropic emitter.

FIG. 10D contains a simulated duo-spot PSF image for a molecule (d,e) oriented at θ=65°, ϕ=10° and wobbling within Ω=0.25π sr with Poisson shot noise and background (brightness of 950 photons and background of 5 photons/pixel) removed. Color bars: normalized intensity

FIG. 10E contains a simulated duo-spot PSF image for a molecule (d,e) oriented at θ=65°, ϕ=10° and wobbling within Ω=0.25π sr with Poisson shot noise and background (brightness of 950 photons and background of 5 photons/pixel) retained. Color bars: photon brightness.

FIG. 10F contains a simulated duo-spot PSF image for a molecule (d,e) oriented at θ=10°, ϕ=45° and wobbling within Ω=0.25π sr with Poisson shot noise and background (brightness of 950 photons and background of 5 photons/pixel) removed. Color bars: normalized intensity

FIG. 10G contains a simulated duo-spot PSF image for a molecule (d,e) oriented at θ=10°, ϕ=45° and wobbling within Ω=0.25π sr with Poisson shot noise and background (brightness of 950 photons and background of 5 photons/pixel) retained. Color bars: photon brightness.

FIG. 10H contains a simulated tri-spot PSF image for the molecule shown in FIG. 10F with Poisson shot noise and background (brightness of 950 photons and background of 5 photons/pixel) removed. Color bars: normalized intensity

FIG. 10I contains a simulated tri-spot PSF image for the molecule shown in FIG. 10G with Poisson shot noise and background (brightness of 950 photons and background of 5 photons/pixel) retained. Color bars: photon brightness.

FIG. 11A contains graphs of orientation spectra estimation precisions for polar angle θ determined from simulated duo-spot PSF images of dipoles at orientations of θ₀=0°-90° and ϕ₀=0°-360° for Ω₀=0 (top two rows), Ω₀=0.5π sr (third row), Ω₀=1.5π sr (fourth row), and Ω₀=3π sr (fifth row), where μₓ₀=sin θ₀ cos ϕ₀ and μ_{y0}=sin θ₀ sin ϕ₀ in the top map. At each orientation, 1000 independent images were generated with a brightness of 950 photons and background of 5 photons/pixel. Orientations of simulated molecules were estimated using a maximum-likelihood estimation algorithm, and the orientation estimation precision was computed by taking the standard deviation of all estimates at each orientation. Due to symmetry with respect to ϕ₀ as shown in the top map, the estimation precision is only reported at ϕ₀=0° (black) and ϕ₀=45° (red) for Ω₀>0 sr.

FIG. 11B contains graphs of orientation spectra estimation precisions for azimuthal angle ϕ determined from simulated duo-spot PSF images of dipoles as described for FIG. 11A at orientations of θ₀=0°-90° and ϕ₀=0°-360° for Ω₀=0 (top two rows), Ω₀=0.5π sr (third row), Ω₀=1.5π sr (fourth row), and Ω₀=3π sr (fifth row), where μₓ₀=sin θ₀ cos ϕ₀ and μ_{y0}=sin θ₀ sin ϕ₀ in the top map.

FIG. 11C contains graphs of orientation spectra estimation precisions for solid angle Ω determined from simulated duo-spot PSF images of dipoles as described for FIG. 11A at orientations of θ₀=0°-90° and ϕ₀=0°-360° for Ω₀=0 (top two rows), Ω₀=0.5π sr (third row), Ω₀=1.5π sr (fourth row), and Ω₀=3π sr (fifth row), where μₓ₀=sin θ₀ cos ϕ₀ and μ_{y0}=sin θ₀ sin ϕ₀ in the top map.

FIG. 12A contains graphs of orientation spectra estimation biases for polar angle θ determined from simulated duo-spot PSF images of dipoles at orientations of θ₀=0°-90° and ϕ₀=0°-360° for Ω₀=0 (top two rows), Ω₀=0.5π sr (third row), Ω₀=1.5π sr (fourth row), and Ω₀=3π sr (fifth row), where μₓ₀=sin θ₀ cos ϕ₀ and μ_{y0}=sin θ₀ sin ϕ₀ in the top map. At each orientation, 1000 independent images were generated with a brightness of 950 photons and background of 5 photons/pixel. Orientations of simulated molecules were estimated using a maximum-likelihood estimation algorithm, and the orientation estimation bias was computed by taking the standard deviation of all estimates at each orientation. Due to symmetry with respect to ϕ₀ as shown in the top map, the estimation precision is only reported at ϕ₀=0° (black) and ϕ₀=45° (red) for Ω₀>0 sr.

FIG. 12B contains a map of orientation spectra estimation biases for azimuthal angle ϕ determined from simulated duo-spot PSF images of dipoles as described for FIG. 12A at orientations of θ₀=0°-90° and ϕ₀=0°-360° for Ω₀=0 (top two rows), Ω₀=0.5π sr (third row), Ω₀=1.5π sr (fourth row), and Ω₀=3π sr (fifth row), where μₓ₀=sin θ₀ cos ϕ₀ and μ_{y0}=sin θ₀ sin ϕ₀ in the top map.

FIG. 12C contains a map of orientation spectra estimation biases for solid angle Ω determined from simulated duo-spot PSF images of dipoles as described for FIG. 12A at orientations of θ₀=0°-90° and ϕ₀=0°-360° for Ω₀=0 (top two rows), Ω₀=0.5π sr (third row), Ω₀=1.5π sr (fourth row), and Ω₀=3π sr (fifth row), where μₓ₀=sin θ₀ cos ϕ₀ and μ_{y0}=sin θ₀ sin ϕ₀ in the top map.

FIG. 13A is a scatter plot showing orientation (polar angle θ) and wobble (solid angle Ω) of Nile red in SPM with various cholesterol levels from 0% to 40% measured using the duo-Spot PSF.

FIG. 13B is a scatter plot showing orientation (polar angle θ) and wobble (solid angle Ω) of Nile red in SPM with various cholesterol levels from 0% to 40% measured using the tri-spot PSF.

FIG. 14A contains graphs of estimated orientation (polar angle, θ) for molecules with various degrees of wobbling: ground truth solid angles Ω₀ of 0 π sr (left), 0.5π sr (center left) 1.5π sr (center right), and 3π sr (right) in gel (blue or light blue) and liquid (red or orange) phase of lipid membrane using the tri-spot (Δ) and duo-spot (×) PSFs. The gray dashed line indicates the ground truth. The diffusion coefficients are 0.005 μm²/s in gel phase and 5 μm²/s in liquid phase. Ω₀: ground truth solid angle; θ₀: ground truth polar angle.

FIG. 14B contains graphs of estimated wobble (solid angle Ω) for molecules with various degrees of wobbling: ground truth solid angles Ω₀ of 0 π sr (left), 0.5π sr (center left) 1.5π sr (center right), and 3π sr (right) in gel (blue or light blue) and liquid (red or orange) phase of lipid membrane using the tri-spot (A) and duo-spot (x) PSFs under the conditions described for FIG. 14A.

FIG. 15A is a histogram of orientation (polar angle θ) of Nile red within a mixture of DOPC/SPM/chol (35:35:30, molar ratio), measured using the tri-spot PSF (red) and duo-spot PSF (orange).

FIG. 15B is a histogram of wobble (solid angle Ω) of Nile red within a mixture of DOPC/SPM/chol (35:35:30, molar ratio), measured using the tri-spot PSF (red) and duo-spot PSF (orange).

FIG. 16A contains scatter plots of discloses orientation (polar angle θ) and wobble (solid angle Ω) of Nile red in the single-phase SLBs consisting of DOPC and SPM+chol (left), and (ii) DOPC+chol, SPM+chol, and SPM+cer (right), imaged using the tri-spot PSF.

FIG. 16B contains scatter plots of discloses orientation (polar angle θ) and wobble (solid angle Ω) of Nile red in the single-phase SLBs consisting of DOPC and SPM+chol (left), and (ii) DOPC+chol, SPM+chol, and SPM+cer (right), imaged using the duo-spot PSF.

FIG. 17A is an MC540 SMLM image showing Lo (dark) and Ld (bright) domains before 5 min of 500 mU/mL SMase treatment in DOPC/SPM/chol (35:35:30, molar ratio) SLBs. Scale bar: 2 μm. Bin size: 28 nm.

FIG. 17B is an MC540 SMLM image showing Lo (dark) and Ld (bright) domains after 5 min of 500 mU/mL SMase treatment in DOPC/SPM/chol (35:35:30, molar ratio) SLBs. Scale bar: 2 μm. Bin size: 28 nm.

FIG. 18A is a scatter plot of orientation (polar angle θ) and wobble (solid angle Ω) of Nile red in single-phase lipid samples consisting of DOPC (3300 data points), SPM+chol (3300 data points), and SPM+cer (3300 data points) using the duo-spot PSF; the 9900 data points in these samples were used to train the SVM classifiers used in FIG. 18B and FIG. 18C.

FIG. 18B is a scatter plot of orientation (polar angle θ) and wobble (solid angle Ω) of Nile red in the single-phase lipid samples of FIG. 18A classified using an SVM based on six second moments and (c) polar and solid angles.

FIG. 18C is a scatter plot of orientation (polar angle θ) and wobble (solid angle Ω) of Nile red in the single-phase lipid samples of FIG. 18A classified using an SVM based on polar and solid angles.

FIG. 19A contains a series of images of Nile red within a mixed DOPC/SPM/chol (35:35:30, molar ratio) SLB, including a conventional MC540 SMLM image (left) and SMOLM images of solid angle (Ω) (center left), polar angle (θ) (center right), and phase-index map (right). The SMOLM maps were generated using the median value of localizations within each bin. Scale bar: 2 μm. Bin size: 28 nm in SMLM, 58.5 nm in SMOLM.

FIG. 19B contains magnified views of the boxed region (3.22×3.39 μm²) of FIG. 19A in three regions selected using Q and object size thresholds. Bin size: 58.5 nm.

FIG. 19C contains histograms of solid angle (left), polar angle (center), and phase index (right) of all localizations within each region of FIG. 19B.

FIG. 19D contains graphs of cumulative distribution functions of the measured solid angle (left), polar angle (center), and phase index (right) from all populations within each region of FIG. 19B.

FIG. 20A contains conventional MC540 SMLM images of DOPC/SPM/chol before (t₀, left) and after (t₃, right) three doses of SMase treatment; Scale bar: 2 μm, Bin size: 28 nm.

FIG. 20B contains a series of magnified views of SMOLM Nile red phase-index map from five boxed regions shown in FIG. 20A at times to (left column), t₂ (center left column), t₃ (center right column), as well as a lipid composition map at t₃ (right column), indicating the lipid composition changes of the existing and newly generated Lₒ domain by SMase. Scale bar: 200 nm, Bin size: 45 nm

FIG. 21 illustrates the back focal plane bases of second-order orientation moment [symbol] μ_{xy} [symbol] .

FIG. 22 illustrates a duo-spot XY PSF phase mask; labels 1 & 2 and the arrows indicate two partitions and slopes of phase ramps that push photons in the partitions toward two directions.

FIG. 23 contains a duo-spot XY PSF image on the image plane; the energy of each spot originates from the corresponding partitions in BFP shown in FIGS. 21 and 22.

FIG. 24 is a schematic diagram of a single molecule imaging device.

FIG. 25A contains a duo-spot XY PSF image of an emitter.

FIG. 25B contains a duo-spot Z PSF image of the emitter of FIG. 25A.

FIG. 25C contains a tri-spot PSF image of the emitter of FIG. 25A.

FIG. 25D contains a quadrated PSF image of the emitter of FIG. 25A.

FIG. 26 contains a series of images illustrating that the image of an oriented emitter at the back focal plane of an objective can be decomposed into a linear combination of second-order orientation moments ( [symbol] μₓ² [symbol] , [symbol] μ_{y}² [symbol] , [symbol] μ_{z}² [symbol] , [symbol] μ_{xy} [symbol] , [symbol] μ_{xz} [symbol] , [symbol] μ_{xy} [symbol] ) with their corresponding basis images, where (μₓ, μ_{y}, μ_{z}) depicts a Cartesian coordinate projection of (θ,ϕ) and [symbol] ⋅ [symbol] represents average operator over camera frame.

FIG. 27 contains images of back focal plane bases of [symbol] μ_{y}² [symbol] (left) and [symbol] μ_{z}² [symbol] (right) second-order orientation moments in the reflected channel.

FIG. 28 is a schematic illustration of a duo-spot Z phase mask in which labels 1 & 2 and the arrows indicate two partitions and slopes of phase ramps that push photons in the partitions toward two directions.

FIG. 29 is a duo-spot Z PSF of an emitter on the image plane in which the energy of each spot originates from the corresponding partitions in the BFPs of FIGS. 27 and 28.

FIG. 30A is a duo-spot XY PSF image of the emitter of FIG. 29.

FIG. 30B is a duo-spot Z PSF image of the emitter of FIG. 29.

FIG. 30C is a tri-spot PSF image of the emitter of FIG. 29.

FIG. 30D is a quadrated PSF image of the emitter of FIG. 29.

FIG. 31A is a bisected PSF image with a dipole orientation of θ=90°, ϕ=45°, Ω=0.

FIG. 31B is a duo-spot XY PSF image with a dipole orientation of θ=90°, ϕ=45°, Ω=0.

FIG. 31C is a duo-spot Z PSF image with a dipole orientation of θ=90°, ϕ=45°, Ω=0.

FIG. 32A is a bisected PSF image with a dipole orientation of θ=0°, Ω=2π.

FIG. 32B is a duo-spot XY PSF image with a dipole orientation of θ=0°, Ω=2π.

FIG. 32C is a duo-spot Z PSF image with a dipole orientation of θ=0°, Ω=2π.

FIG. 33A contains duo-spot XY (left) and duo-spot Z (right) PSF images with a dipole orientation of θ=90°, ϕ=0°, and Ω=0.14π.

FIG. 33B contains duo-spot XY (left) and duo-spot Z (right) PSF images with a dipole orientation of θ=90°, ϕ=30°, and Ω=0.14π.

FIG. 33C contains duo-spot XY (left) and duo-spot Z (right) PSF images with a dipole orientation of θ=90°, ϕ=60°, and Ω=0.14π.

FIG. 33D contains duo-spot XY (left) and duo-spot Z (right) PSF images with a dipole orientation of θ=90°, ϕ=90°, and Ω=0.14π.

FIG. 33E contains duo-spot XY (left) and duo-spot Z (right) PSF images with a dipole orientation of θ=90°, ϕ=30°, and Ω=0.

FIG. 33F contains duo-spot XY (left) and duo-spot Z (right) PSF images with a dipole orientation of θ=90°, ϕ=30°, and Ω=0.54π.

FIG. 33G contains duo-spot XY (left) and duo-spot Z (right) PSF images with a dipole orientation of θ=90°, ϕ=30°, and Ω=2π.

FIG. 33H contains duo-spot XY (left) and duo-spot Z (right) PSF images with a dipole orientation of θ=90°, ϕ=30°, and Ω=4π.

FIG. 34A is a graph showing the best achievable estimation precision for azimuthal angle ϕ calculated from Cramér-Rao bound theory for a dipole emitter oriented in the xy plane (θ=90°) at a solid angle Ω of 0.015π.

FIG. 34B is a graph showing the best achievable estimation precision for solid angle Ω calculated from Cramér-Rao bound theory for a dipole emitter oriented in the xy plane (θ=90°) at a solid angle Ω of 0.015π.

FIG. 34C is a graph showing the best achievable estimation precision for azimuthal angle ϕ calculated from Cramér-Rao bound theory for a dipole emitter oriented in the xy plane (θ=90°) at a solid angle Ω of 0.14π.

FIG. 34D is a graph showing the best achievable estimation precision for solid angle Ω calculated from Cramér-Rao bound theory for a dipole emitter oriented in the xy plane (θ=90°) at a solid angle Ω of 0.14π.

FIG. 34E is a graph showing the best achievable estimation precision for azimuthal angle ϕ calculated from Cramér-Rao bound theory for a dipole emitter oriented in the xy plane (θ=90°) at a solid angle Ω of 1.2π.

FIG. 34F is a graph showing the best achievable estimation precision for solid angle Ω calculated from Cramér-Rao bound theory for a dipole emitter oriented in the xy plane (θ=90°) at a solid angle Ω of 1.2π.

FIG. 35 is a block diagram schematically illustrating a system in accordance with one aspect of the disclosure.

FIG. 36 is a block diagram schematically illustrating a computing device in accordance with one aspect of the disclosure.

FIG. 37 is a block diagram schematically illustrating a remote or user computing device in accordance with one aspect of the disclosure.

FIG. 38 is a block diagram schematically illustrating a server system in accordance with one aspect of the disclosure.

There are shown in the drawings arrangements that are presently discussed, it being understood, however, that the present embodiments are not limited to the precise arrangements and are instrumentalities shown. While multiple embodiments are disclosed, still other embodiments of the present disclosure will become apparent to those skilled in the art from the following detailed description, which shows and describes illustrative aspects of the disclosure. As will be realized, the invention is capable of modifications in various aspects, all without departing from the spirit and scope of the present disclosure. Accordingly, the drawings and detailed description are to be regarded as illustrative in nature and not restrictive.

### DETAILED DESCRIPTION

A defining feature of soft matter is the impact of thermal fluctuations on the organization and self-assembly of molecules into mesoscopic structures like lipid membranes—processes that are notoriously difficult to observe directly. SMOLM extends conventional SMLM to measure both the positions and 3D orientations of >10⁵ single fluorescent molecules with high precision in under 5 minutes. Here, we have utilized the orientation and rotational dynamics of fluorescent probes to reveal their interactions with the surrounding environment, such as the ordering of and condensation dynamics within lipid membranes. The present disclosure demonstrates the feasibility of a new type of nanoscale imaging spectroscopy, namely measuring single-molecule orientation spectra, i.e., the six orientational second moments of dipole emitters, to resolve nanoscale chemical properties, similar to classic spectroscopies such as absorption, fluorescence emission, fluorescence lifetime, and NMR.

We developed single-molecule orientation localization microscopy, also referred to herein as SMOLM, to directly measure the orientation spectra (3D orientation plus “wobble”) of lipophilic probes transiently bound to lipid membranes. SMOLM measurements reveal that Nile red's (NR) orientation spectra are extremely sensitive to the chemical composition of lipid membranes. SMOLM images resolve nanodomains and enzyme-induced compositional heterogeneity within membranes, where NR within liquid-ordered vs. liquid-disordered domains shows a ˜4° difference in polar angle and a ˜0.4π sr difference in wobble angle. As a new type of imaging spectroscopy, SMOLM sheds light on the organizational and functional dynamics of lipid-lipid, lipid-protein, and other soft matter assemblies at the single-molecule level with nanoscale resolution.

In order to achieve high spatiotemporal resolution and sufficient sampling density, we apply the PAINT (points accumulation for imaging in nanoscale topography) blinking mechanism, in which certain lipophilic dyes exhibit fluorescence solely while in a non-polar environment. We thereby resolve nanoscale lipid domains with resolution beyond the diffraction limit and monitor in-situ lipid compositional changes induced by low doses of sphingomyelinase. SMOLM imaging clearly shows its potential to resolve interactions between various lipid molecules, enzymes, and fluorescent probes with detail that has never been achieved previously.

There exist numerous imaging technologies that characterize the orientation and wobble of single molecules with varying degrees of sensitivity and resolution. To date, no existing technique is capable of imaging the nanoscale positions and 3D orientations of >10⁵ molecules with single-molecule sensitivity and sufficient spatiotemporal resolution to visualize, for example, the dynamic remodeling of a lipid bilayer. Such multidimensional imaging is critical for capturing the detailed mechanisms of complex dynamical processes in even relatively simple biological systems. To address these limitations, we have developed a computational imaging technology called SMOLM, single-molecule orientation localization microscopy, comprising 1) an orientation-sensitive engineered point spread function (PSF) to efficiently encode the 3D orientation and wobble of dipole-like emitters into fluorescence images and 2) a maximum likelihood estimator that promotes sparsity for estimating molecular position, orientation, and wobble from those images robustly and accurately. This combination of hardware and software is critical for resolving molecular positions and orientations unambiguously and accurately; otherwise, neighboring molecules, wobbling molecules, and translationally diffusing molecules could be confused with one another.

### Localization and Orientation Estimation of SMOLM

We model a fluorescent molecule as a dipole-like emitter wobbling within a cone. An orientational unit vector

μ=[μₓ,μ_{y},μ_{z}]^{T}=[sin θ cos ϕ, sin θ sin ϕ, cos θ]^{T}

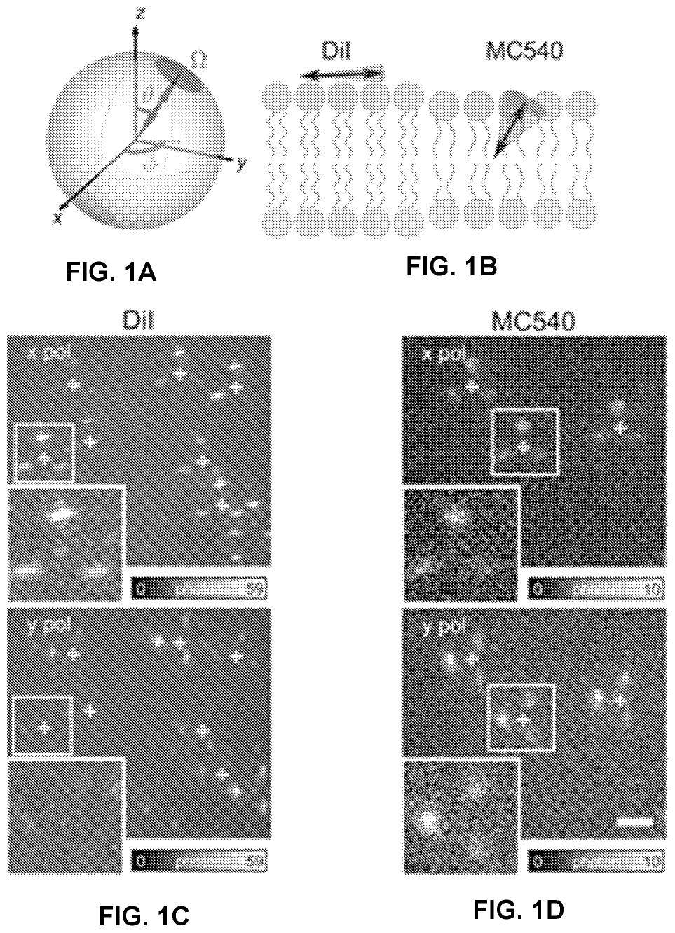

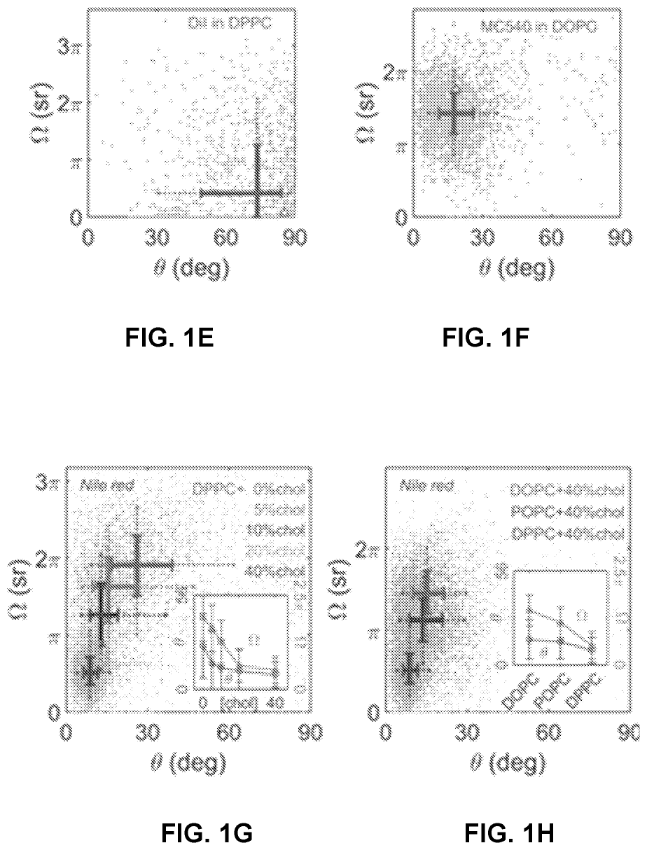

and a solid angle Ω define the center orientation and the wobbling area of the cone, respectively (FIG. 1A).

Assuming that a molecule's rotational correlation time is faster than its excited state lifetime and the camera acquisition time, its orientation state can be fully characterized by a second-moment vector

m=[ [symbol] μₓ² [symbol] , [symbol] μ_{y}² [symbol] , [symbol] μ_{z}² [symbol] , [symbol] μₓμ_{y} [symbol] , [symbol] μₓμ_{z} [symbol] , [symbol] μ_{y}μ_{z} [symbol] ]^{T},

where each component is a time-averaged second moment of μ within a single camera acquisition period.

A fluorescence microscope image of such an emitter captured by an n-pixel camera I∈ [symbol] ⁿ can be modeled as a linear superposition of six basis images weighted by m as follows:

I=sBm+b=s[Bₓₓ,B_{yy},B_{zz},B_{xy},B_{xz},B_{yz}]m+b, (1)

where s is the number of photons detected from the molecule and b is the number of background photons in each pixel. Each so-called basis image Bₖ∈ [symbol] ⁿ (k∈{xx, yy, zz, xy, xz, yz}) corresponds to the response of the optical system to each orientational second-moment component mₖ and can be calculated by the vectorial diffraction theory.

In the present disclosure, the locations and orientations of single molecules were estimated simultaneously using a sparsity-promoting maximum likelihood estimator. Briefly, the object space is represented by a rectangular lattice of grid points with spacing equal to the camera pixel size (58.5 nm). Each grid point may contain at most a single molecule parameterized by brightness, position offsets, and six orientational second moments.

To robustly estimate the number of underlying molecules and their parameters in the presence of SM image overlap, we use a regularized maximum likelihood exploiting a group-sparsity norm to estimate the parameters of each grid point. The algorithm begins by estimating the strength, i.e., brightness, of each of the second moments \tilde{m}ₖ independently at all object grid points. We next pool together localizations, i.e., their brightnesses and position offsets, across the six second moments to identify the most likely molecules in the object space. Once we identify these molecules, we solve a constrained maximum likelihood to minimize systematic biases induced by the sparsity norm, yielding estimates of the brightnesses, locations, and orientations (second moments \tilde{m}) of all molecules in the image. We remove localizations with signal estimates of less than 400 photons detected to eliminate unreliable localizations.

The estimated second-moment vectors \tilde{m} were next projected to the physical orientation space (polar angle θ, azimuthal angle ϕ, and wobbling area Ω of a transition dipole moment μ) by a weighted least-square estimator:

$$( θ , ϕ , Ω ) = {argmin}_{\hat{θ} , \hat{ϕ} , \hat{Ω}} {( \tilde{m} - m ( \hat{θ} , \hat{ϕ} , \hat{Ω} ) )}^{T} FIM ( \tilde{m} - m ( \hat{θ} , \hat{ϕ} , \hat{Ω} ) ) \\ such that \qquad ( 2 )$$

$$m ( θ , ϕ , Ω ) = {[ 〈 {μ}_{x}^{2} 〉 , 〈 {μ}_{y}^{2} 〉 , 〈 {μ}_{z}^{2} 〉 , 〈 {μ}_{x} {μ}_{y} 〉 , 〈 {μ}_{x} {μ}_{z} 〉 , 〈 {μ}_{y} {μ}_{z} 〉 ]}^{T} , \qquad ( 3 )$$

$$〈 {μ}_{x}^{2} 〉 = γ {μ}_{x}^{2} + \frac{1 - γ}{3} , 〈 {μ}_{x} {μ}_{y} 〉 = γ {μ}_{x} {μ}_{y} , \qquad ( 4 )$$

$$〈 {μ}_{y}^{2} 〉 = γ {μ}_{y}^{2} + \frac{1 - γ}{3} , 〈 {μ}_{x} {μ}_{z} 〉 = γ {μ}_{x} {μ}_{z} , \qquad ( 5 )$$

$$〈 {μ}_{z}^{2} 〉 = γ {μ}_{z}^{2} + \frac{1 - γ}{3} , 〈 {μ}_{y} {μ}_{z} 〉 = γ {μ}_{y} {μ}_{z} , \qquad ( 6 )$$

$$[ {μ}_{x} , {μ}_{y} , {μ}_{z} ] = [ sin θcos ϕ , sin θsin ϕ , cos θ ] , and \qquad ( 7 )$$

$$γ = \frac{1}{2} {cos}^{2} ( 2 arcsin \sqrt{\frac{Ω}{8 π}} ) + \frac{1}{2} cos ( 2 arcsin \sqrt{\frac{Ω}{8 π}} ) , \qquad ( 8 )$$

where γ is the rotational constraint and FIM is the Fisher information (FI) matrix calculated from the basis images. Here, we define the FI matrix associated with estimating the six orientational second moments m as

$$FIM = {\sum }_{i = 1}^{n} \frac{1}{{I}_{i}} ∇ {I}_{i}^{T} ∇ {I}_{i} , \qquad ( 9 )$$

where i denotes the i^{th} pixel of an image I∈ [symbol] n captured by a camera and

$$∇ {I}_{i} = [ \frac{\partial {I}_{i}}{\partial {m}_{xx}} , \frac{\partial {I}_{i}}{\partial {m}_{yy}} , \frac{\partial {I}_{i}}{\partial {m}_{zz}} , \frac{\partial {I}_{i}}{\partial {m}_{xy}} , \frac{\partial {I}_{i}}{\partial {m}_{xz}} , \frac{\partial {I}_{i}}{\partial {m}_{yz}} ] .$$

Due to the linearity of the forward imaging model (1) in terms of the second moments, the FI matrix can be further simplified as

$$FIM = {\sum }_{i = 1}^{n} \frac{{s}^{2}}{{I}_{i}} {B}_{i}^{T} {BI}_{i} . \qquad ( 10 )$$

where Bᵢ represents the i^{th} row of B∈ [symbol] ^{n×6}. The weighted least square estimation can be efficiently performed by caching Hadamard products of each pair of the basis images. Note that \tilde{m} and m denote second moment outputs of the maximum likelihood estimator and the weighted least-square estimator respectively. The FI matrix assigns weights to each orientational component mₖ inversely proportional to the expected measurement variance of the PSFs used in SMOLM. We minimized (2) using the f mincon function in MATLAB (Mathworks, R2019a). The eigenvector corresponding to the largest eigenvalue of the second moment matrix was assigned as the initial orientation of the minimization of (2).

### PSF Design and Selection

SMOLM can use any PSF that encodes SM orientation and wobble into its images. By way of non-limiting example, an existing tri-spot PSF provides highly accurate and precise measurements of SM orientation and wobbling by redistributing the photons from an SM into three spots (in both x- and y-polarized detection channels), as illustrated in FIG. 25C. By way of another non-limiting example, an existing quadrated PSF redistributes the photons from an SM into four spots (in both x- and y-polarized detection channels), as illustrated in FIG. 25D. As the photons from an SM are redistributed into higher and higher numbers of spots, each spot exhibits smaller signal-to-background ratio (SBR) compared to the standard single spot PSF. In applications with weakly emitting fluorescent molecules or high fluorescence background, a significant fraction or even a majority of SM flashes may not be detectable using the Tri-spot PSF.

Using the Tri-spot PSF, we observed that the average photons detected from single Nile red molecules decreased from 1365±549 (median±std) in a DOPC/DPPC/chol mixture to 883±301 in DOPC/SPM/chol. This decrease could be due to a smaller quantum yield (QY) and a blue-shift in the fluorescence of Nile red in the presence of SPM+chol (QY, 45%; em, 586 nm) compared to DPPC+chol (QY, 60%; em, 595 nm). This observation drove us to choose a different orientation-sensitive PSF with improved SBR for SMOLM imaging in DOPC/SPM/chol lipid membranes.

### Design of the Duo-Spot PSF

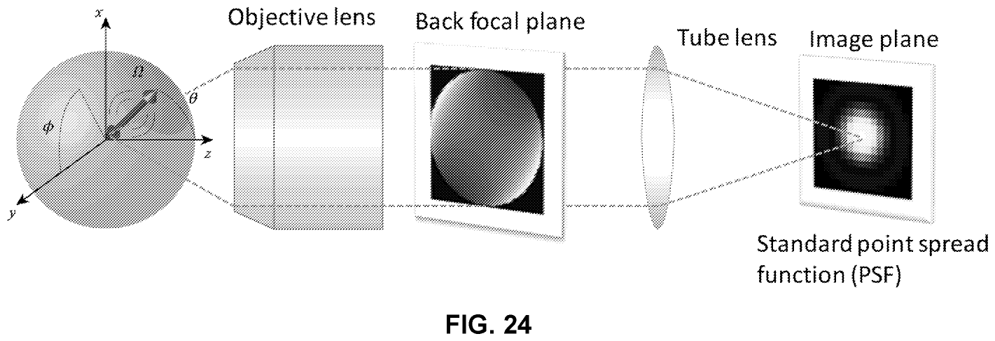

An image of a fluorescent emitter, e.g., a molecule or nanoparticle, depends on its orientation. The image also contains information on how much a molecule rotates during a camera frame (called its wobbling). We model individual fluorescent molecules as dipoles. We assume a molecule rotates (wobbles) within a symmetric cone during one exposure time. Then we can use θ,ϕ to describe the center orientation of the cone and use solid angle Ω [sr] to describe the wobbling unit area on the unit sphere (Ω=0 means fixed dipole emitter and Ω=4π means a freely rotating, isotropic emitter). Although orientation information is contained within the light captured by a microscope, the traditional imaging system that creates the standard point spread function (PSF) (see FIG. 24) cannot convey this information to the image captured by a camera.

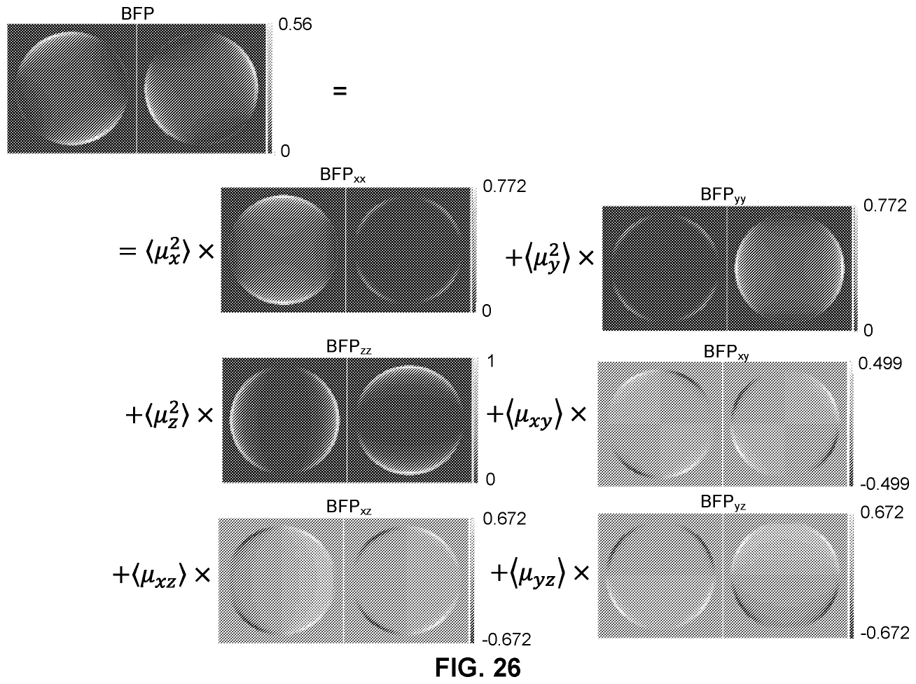

The image of an oriented emitter at the back focal plane of an objective can be decomposed into a linear combination of second-order orientation moments text use ( [symbol] μₓ² [symbol] , [symbol] μ_{y}² [symbol] , [symbol] μ_{z}² [symbol] , [symbol] μ_{xy} [symbol] , [symbol] μ_{xz} [symbol] , and [symbol] μ_{yz} [symbol] ) with their corresponding basis images (see below), where (μₓ, μ_{y}, μ_{z}) depicts a Cartesian coordinate projection of (θ,ϕ) and [symbol] ⋅ [symbol] represents average operator over camera frame (see FIG. 26). In various aspects, the design of the duo-spot PSFs disclosed herein is inspired by the distribution of the basis function on the back focal plane.

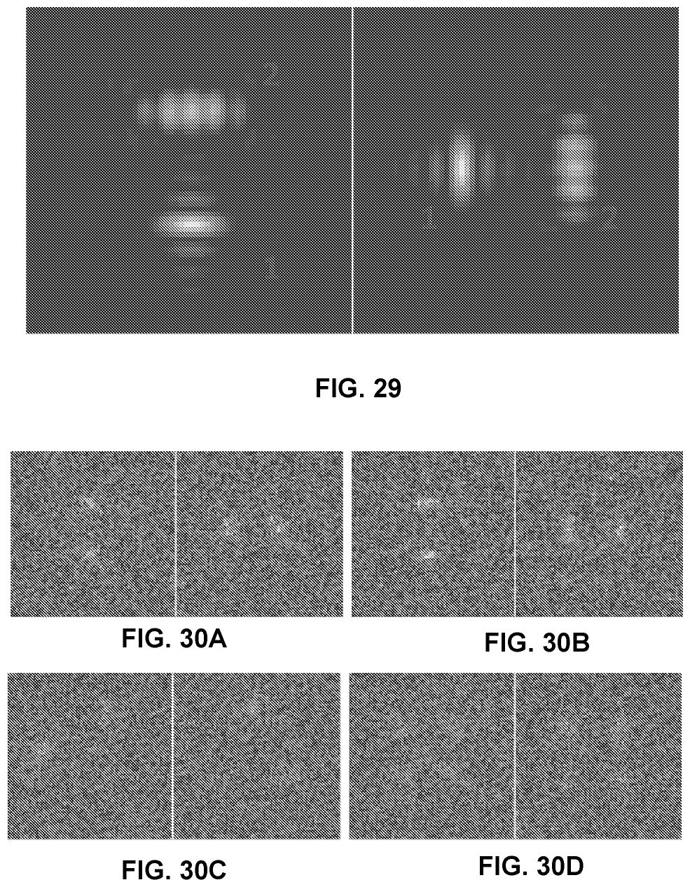

In various aspects, a Duo-spot PSF is disclosed that redistributes the photons of an emitter into two spots. In various aspects, the Duo-spot PSF imaging is accomplished using a Duo-spot PSF phase mask that includes at least three partitions, as illustrated in FIGS. 22 and 28. Each partition is a subset of the total area of the phase mask, and each partition includes a phase delay ramp aligned along one of two phase delay axes. Each phase delay ramp includes a gradient of phase delays, and the two phase delay axes are oriented in different directions. Each phase delay axis, which may define the orientation of at least one or more partitions of the phase delay mask, directs a portion of the light emitted by the emitter to one of the two spots as illustrated, for example, in FIG. 29. The relative brightness of the two spots of the duo-spot PDF encodes an orientation and a rotational mobility of the single point emitter.

The duo-spot PSF phase mask may include any number of partitions without limitation. In various aspects, the duo-spot PSF phase mask includes three partitions (FIG. 28), four partitions (FIG. 22), five partitions, six partitions, seven partitions, eight partitions, nine partitions, ten partitions, or more partitions. In all aspects, each of the partitions of the duo-spot phase mask includes a phase delay ramp aligned along one or the other of two phase delay axes.

In various aspects, each spot of the duo-spot PSF is associated with one of the two phase delay axes. To ensure separation of the two spots, the two phase delay axes are oriented in two different directions. In various aspects, each phase delay axis may be oriented in any direction without limitation, so long as the orientations of the two phase delay axes are in different directions. In some aspects, the orientation of the two phase delay axes are parallel to a common axis, but in opposite directions.

In various aspects, the shapes of the partitions, as well as the orientations of the phase delay axes associated with each partition, may be selected to separate at least one aspect of at least one basis image from the remaining basis images, as described in additional detail below.

In some aspects, the Duo-spot PSF imaging is accomplished using a Duo-spot PSF phase mask that is configured to separate one basis image, including but not limited to Bₓₓ, B_{yy}, and B_{zz}, illustrated in FIG. 26, from the remaining basis images in the x-polarized image channel and the y-polarized image channel. In other aspects, Duo-spot PSF imaging is accomplished using a Duo-spot PSF phase mask that is configured to separate the positive and negative energies associated with one basis image, including, but not limited to, B_{xy}, B_{yz}, and B_{xz}, illustrated in FIG. 26, into two separate spots.

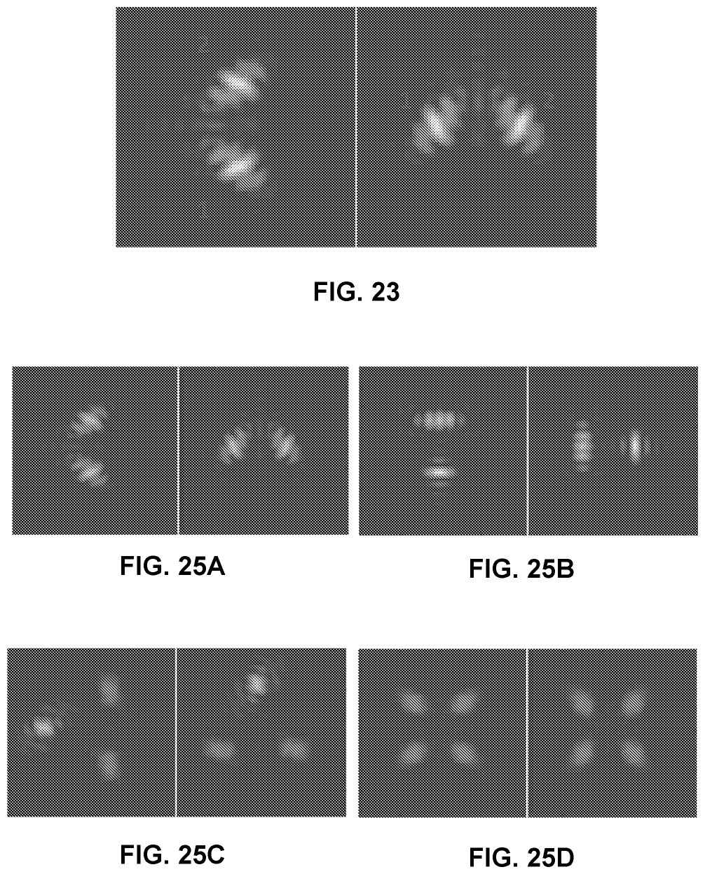

In one aspect, a Duo-spot XY PSF was designed to separate the positive and negative energies associated with the basis image B_{xy}, illustrated in FIG. 21, into two separate spots The Duo-spot XY phase mask (see FIG. 22) splits the BFP into two regions, as shown in FIG. 23.

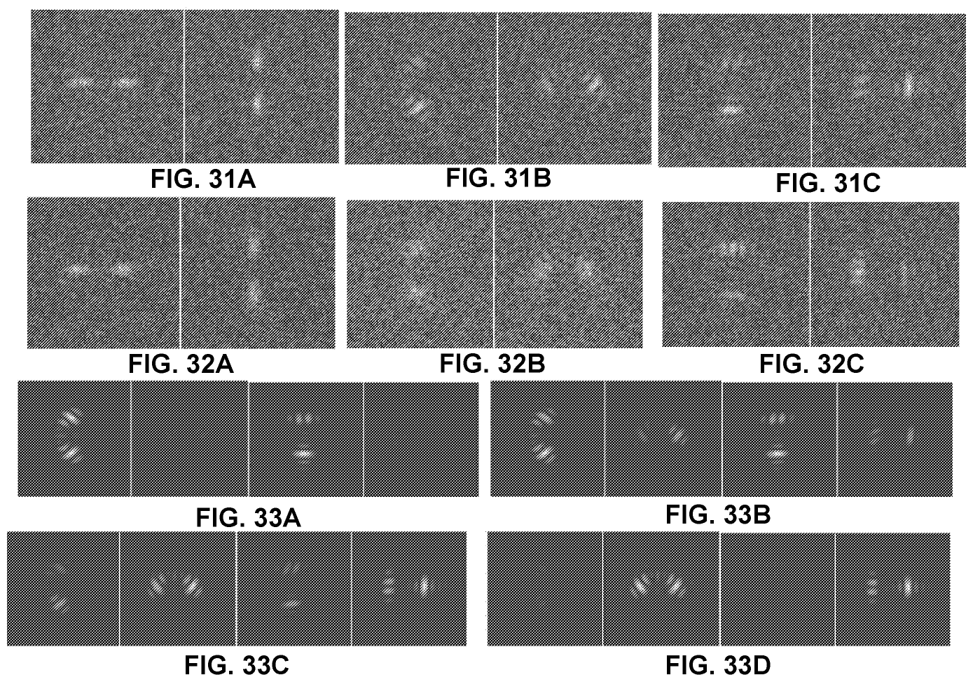

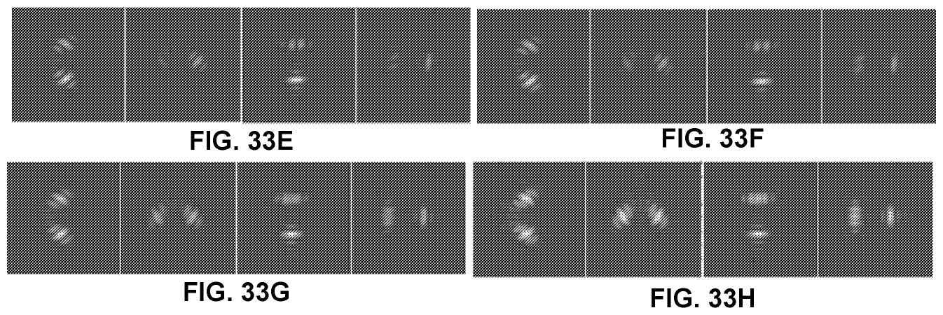

The Duo-spot PSFs overcome at least a portion of the shortcomings of previous PSFs. FIG. 25A and FIG. 25B are a Duo-spot XY PSF image and a Duo-spot Z PSF image compared to a tri-spot PSF image (FIG. 25C) and a quadrated PSF image (FIG. 25D). The spots on both Duo-spot PSF images are brighter with respect to the background than either the tri-spot or quadrated PSF images. As illustrated in FIGS. 30A, 30B, 30C and 30D, Duo-spot PSFs (FIGS. 30A and 30B) provide higher detectability for a localization software than 3- or 4-spot PSFs (e.g., tri-spot (FIG. 30C) or quadrated (FIG. 30D)) under very low signal-to-noise ratio conditions. As illustrated in FIGS. 31 and 32, duo-spot PSFs (FIGS. 31B, 31C, 32B, and 32C) are capable of resolving emitter orientations that are ambiguous when using an existing 2-spot PSF, bisected (FIG. 31A and FIG. 32A), thus leading to more accurate orientation estimation within the sphere. As illustrated in FIG. 33, duo-spot PSFs provide superior sensitivity for orientation measurement especially when emitters are in-plane (θ=90°).

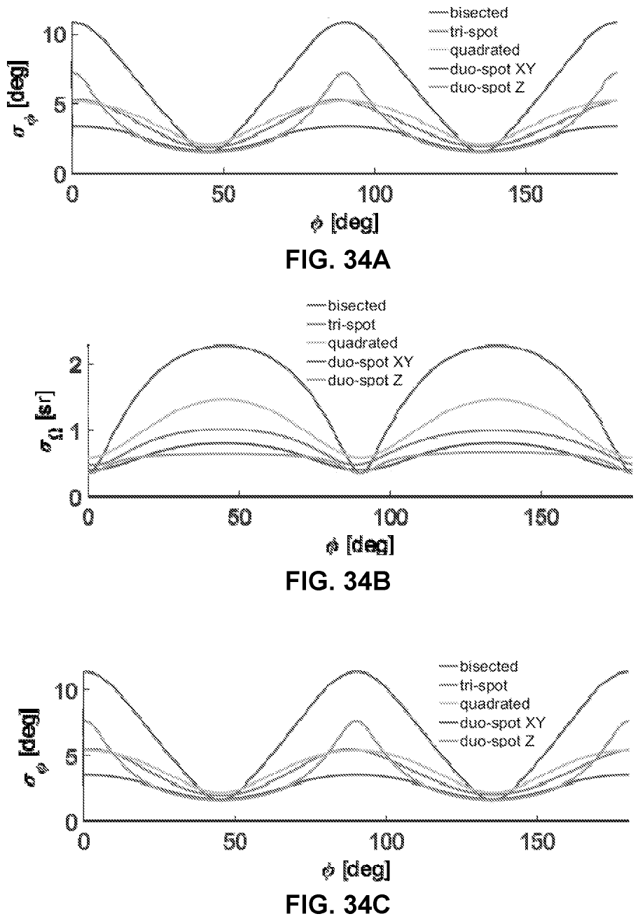

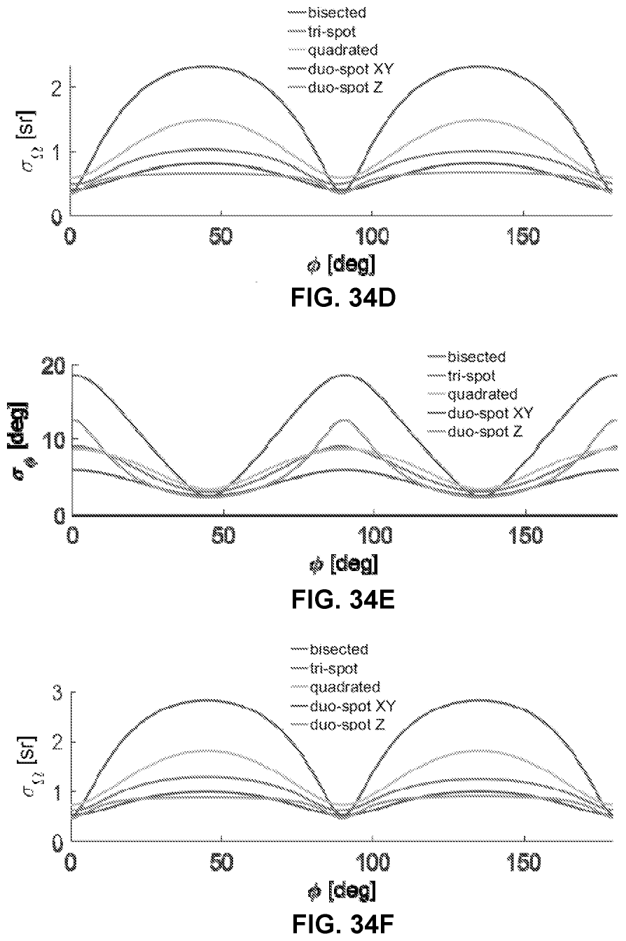

FIG. 34 is a series of graphs summarizing the best achievable estimation precision calculated from Cramér-Rao bound theory, illustrating that the duo-spot PSFs provide smaller uncertainty for ϕ, Ω estimation compared to conventional PSFs, i.e., bisected, tri-spot and quadrated. The graphs illustrated in FIG. 34 are for a dipole emitter oriented in the xy plane (θ=90°).

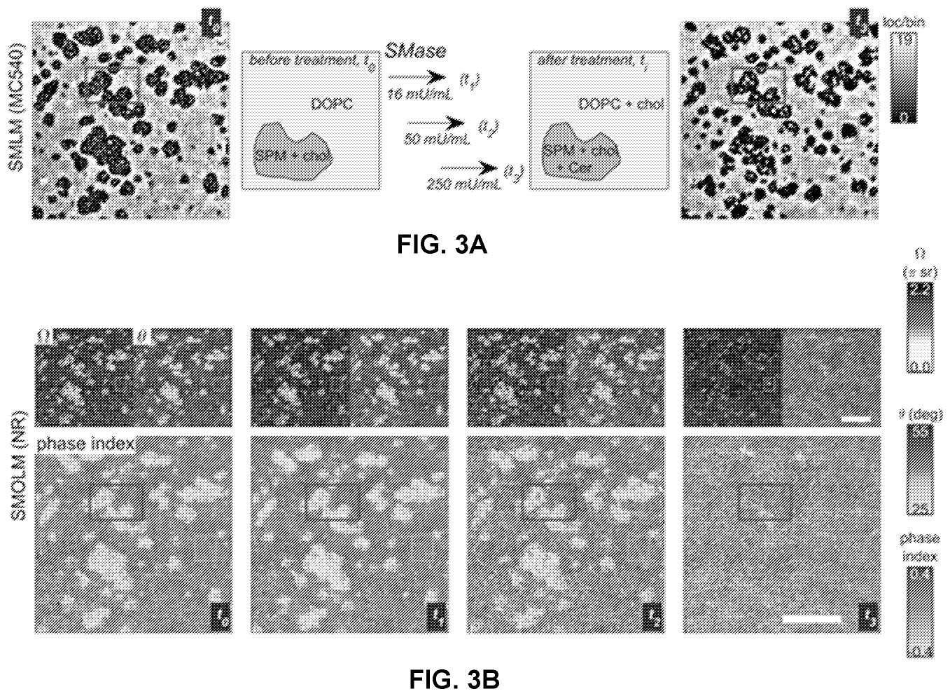

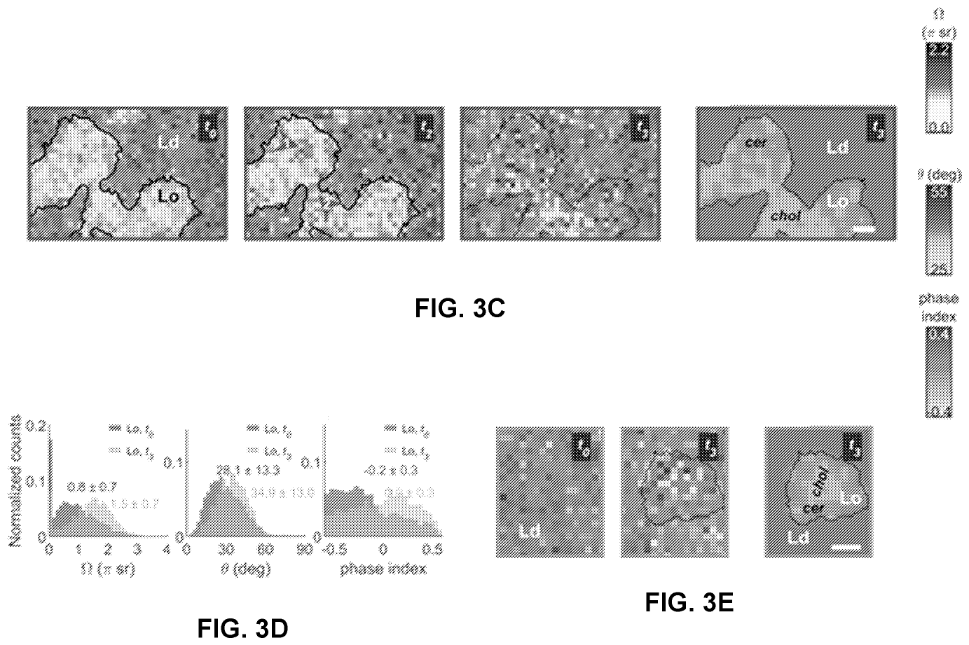

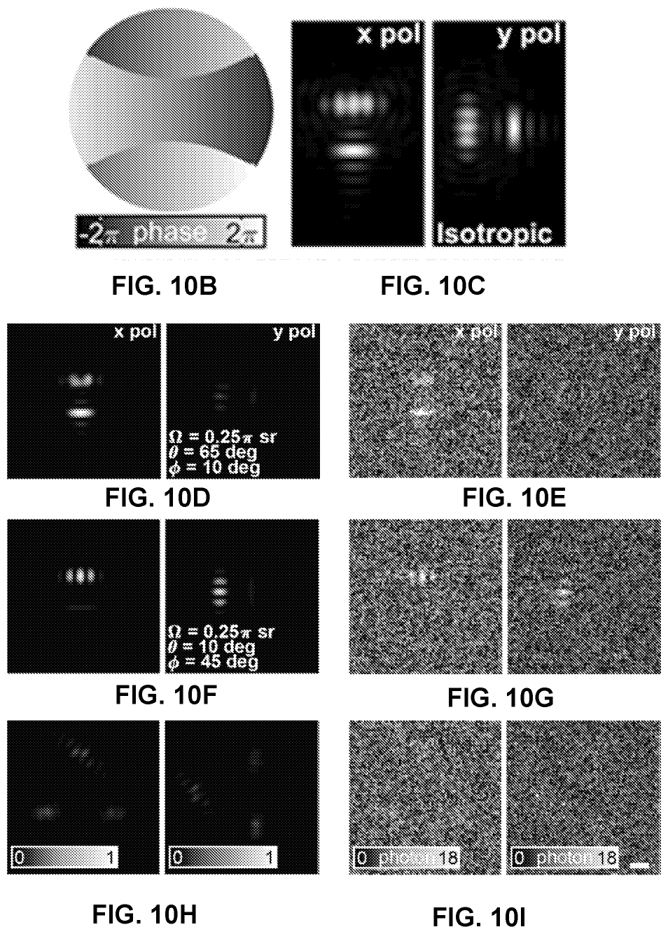

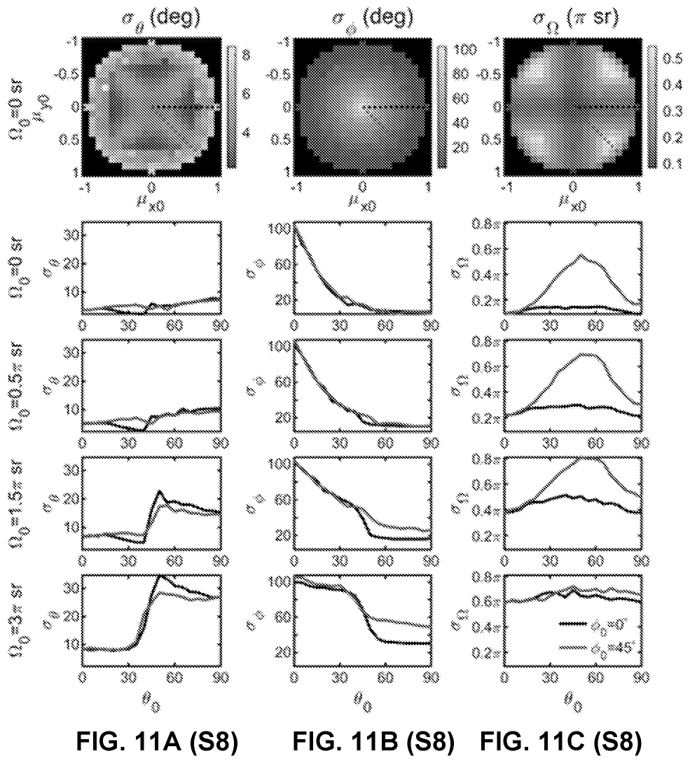

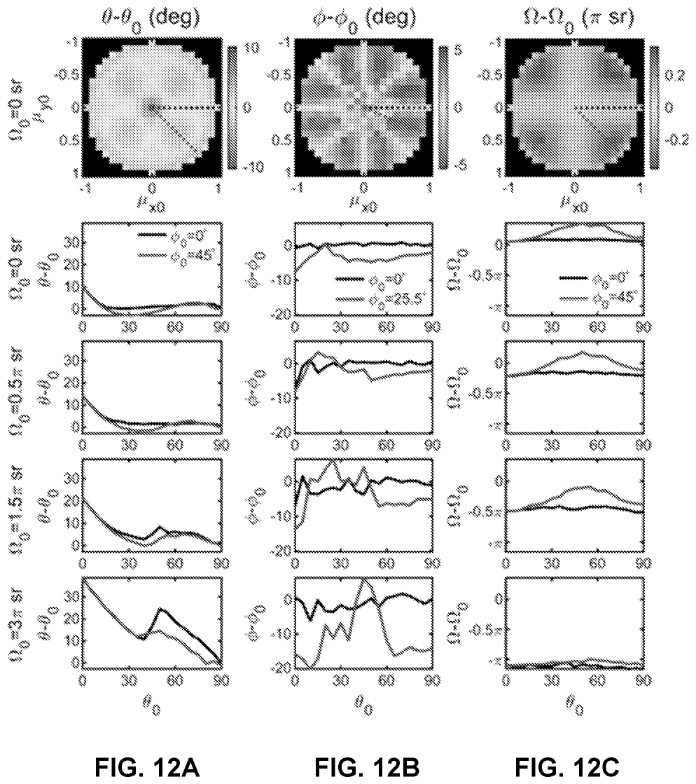

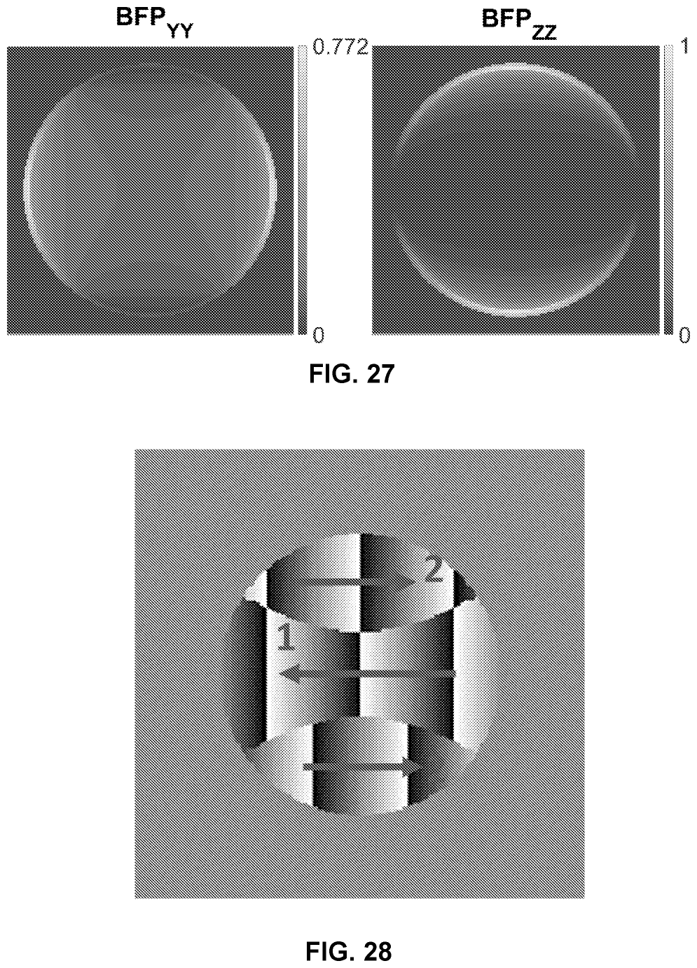

In one aspect, a Duo-spot Z PSF was designed to separate the B_{zz} basis image from Bₓₓ in x-polarized channel and B_{yy} in y-polarized channel for improved polar angle (θ) estimation in SMOLM. In order to achieve this goal, we focused on the intensity distributions of the B_{yy} and B_{zz} bases (see FIG. 27) at the back focal plane (BFP) in the y channel (FIG. 10A, the B_{yy} and B_{zz} bases images in x-polarized channel are similar but 90° rotated). The Duo-spot Z phase mask (see FIG. 28) splits the BFP into two regions, as shown in FIG. 10B and in FIG. 29. Although the Duo-spot Z PSF exhibits two bright spots in response to an isotropic emitter or a dipole emitter with Ω=4π sr (FIG. 10C), the brightness ratio between the two spots in each channel depends on the polar angle θ if the wobbling area Ω is relatively small (e.g. Ω=0.25π sr, FIGS. 10D, 10E, 10F, and 10G). This response essentially produces well-focused, approximately single-spot images when molecules exhibit large or small polar angles (θ≈0° or θ≈90°) and allows such molecules to be detected efficiently under low SBR conditions compared to the Tri-spot PSF (FIGS. 10H and 10I). The Duo-spot PSF with the maximum-likelihood estimation algorithm yields good estimation precision (σ_{θ}^{ave}=11.2°, σ_{ϕ}^{ave}=39.3°, σ_{Ω}^{ave}=0.47π sr) and bias (|θ−θ₀|^{ave}=6.0°, |ϕ−ϕ₀|^{ave}=3.9°, |Ω−Ω₀|^{ave}=0.42π sr) for the orientation spectra of fluorescent molecules (FIGS. 11 and 12). We utilized the Duo-spot Z PSF in the SMOLM imaging of SMase-induced lipid composition alteration and domain reorganization (FIG. 3) as described herein.

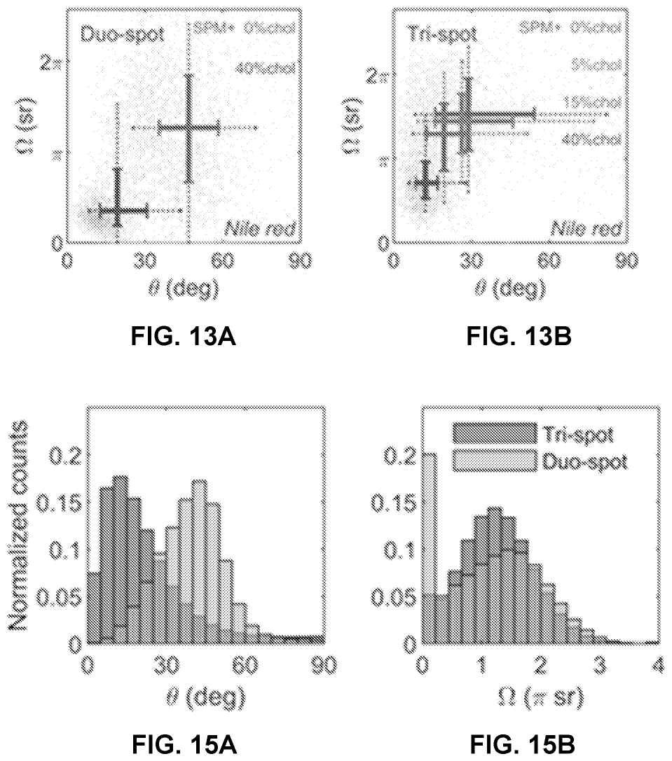

Experimentally, we used the Duo-spot Z PSF to image the orientation spectra of Nile red in the presence of increased chol. As shown in FIG. 13A, both the polar angle and solid angle of Nile red decrease when the chol concentration increases from 0% to 40% in SPM. This trend matches our observations of Nile red in SPM using the Tri-spot PSF (FIG. 13B).

### SMOLM Imaging

In various aspects, any known SMOLM system may be used to perform SMOLM imaging, including, but not limited to, the use of a Duo-Spot PSF phase mask as described herein. Exemplary SMOLM systems are described in detail in U.S. Patent Application Publication 2018/0307132, the contents of which are incorporated by reference herein in their entirety.

In one aspect, a home-built microscope with a 100× objective lens (NA 1.40, Olympus, UPLSAPO100XOPSF) may be used to perform SMOLM imaging. For NR and MC540 imaging, a 561-nm laser (Coherent Sapphire) with a peak intensity of 1.31 kW/cm² and a dichroic beamsplitter (Semrock, Di03-R488/561) were used. The emission was filtered by a bandpass filter (Semrock, FF01-523/610), and separated into x- and y-polarized channels by a polarization beam splitter (PBS, Meadowlark Optics, BB-100-VIS). The Tri-spot and Duo-spot phase masks were generated by a spatial light modulator (Meadowlark Optics, 256 XY Phase Series) onto which the back focal plane of both polarization channels was projected. The modulated SMOLM images were captured with a typical 30 ms integration time using an sCMOS camera (Hamamatsu ORCA-flash4.0 C11440-22CU). A 514-nm laser (Coherent Sapphire) with a peak intensity of 1.56 kW/cm², dichroic beamsplitter of Di0₂-R514, and bandpass filter of FF01-582/64 was used for DiI imaging. Tris buffer or GLOX buffer (only for MC540) was used as imaging buffer.

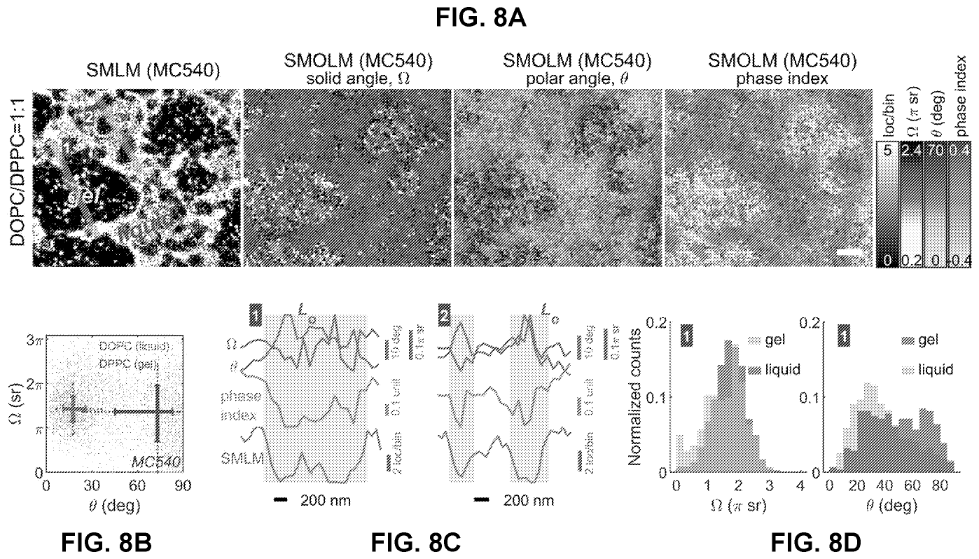

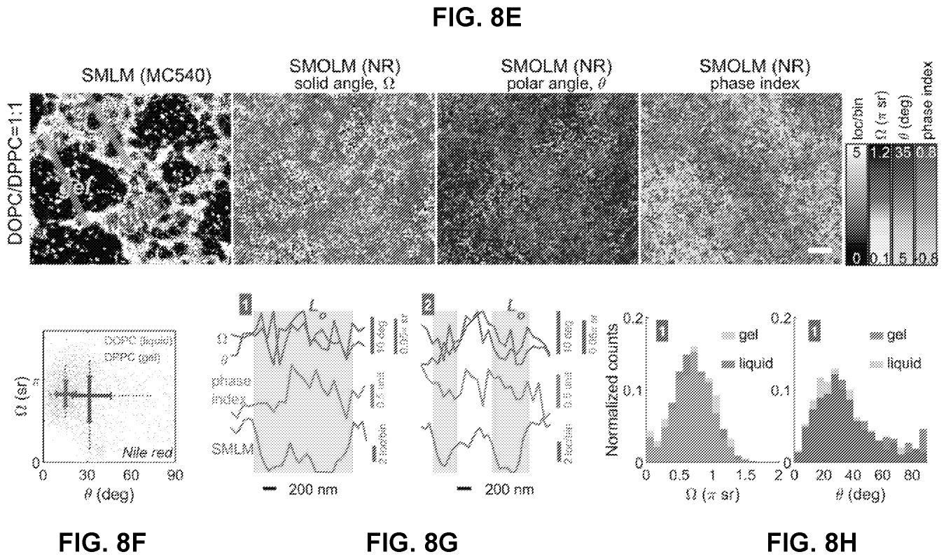

To achieve optimal SMOLM imaging, one must select the best combination of orientation-sensitive probes and PSFs to distinguish lipid phases/compositions with high spatiotemporal resolution. First, we choose the probe whose orientation spectra are most separable between various single lipid phases. For example, in single-phase SLBs of DOPC and DPPC, MC540 shows a larger separation in polar angle (Δθ_{DPPC-DOPC}=55.6°, FIG. 8B) than that of NR (Δθ_{DPPC-DOPC}=16.4°, FIG. 8F).

To achieve better SMOLM imaging, one must select the probe whose orientation spectra across various lipid phases are most separable. For example, to optimize SMOLM for resolving gel and liquid phases within a mixture of DOPC/DPPC (1:1, molar ratio), we measured the orientation spectra of MC540 and Nile red in a single-component DPPC (gel) SLB and a DOPC (liquid) SLB.

MC540 exhibits preferential orientations in different lipid membrane phases, which was previously measured for an ensemble or bulk collection of molecules. We used SMOLM to measure the orientation of MC540 at the single-molecule (SM) level (FIG. 8B). In DPPC (gel phase), our results indicate that MC540 exhibits large polar angles (θ=73.1±23.7°) and wide distribution of solid angles (Ω=1.36π±0.82π sr); whereas in DOPC (liquid phase), MC540 shows small polar angles (θ=17.5±14.2°) and a narrower distribution of solid angles (Ω=1.42π±0.44π sr). The results match well with the literature reports.

The orientation of single Nile red molecules within lipid membranes has never been measured before. Our SMOLM results (FIG. 8F) indicate that Nile red exhibits out-of-plane orientations (θ=15.1±11.3°) in DOPC (liquid phase) SLBs with a solid angle (Ω) of 1.64π±0.47π sr. The polar angle (θ) of Nile red increases to 31.5±21.4° in DPPC (gel phase) SLBs with slightly deceased solid angles (Ω=1.61π 0.75π sr) (FIG. 8F).

Our measurements show that the polar angle of MC540 exhibits larger separation (Δθ_{DPPC-DOPC}=55.6°) in DOPC versus DPPC than Nile red (Δθ_{DPPC-DOPC}=16.4°). We therefore compared SMOLM imaging using MC540 (FIGS. 8A, 8B, 8C, 8D) versus Nile red (FIGS. 8E, 8F, 8G, 8H) for a mixed DOPC/DPPC SLB (1:1, molar ratio) from the same field of view.

In the mixture of DOPC/DPPC, conventional MC540 SMLM resolves both gel (dark regions in FIG. 8A, left) and liquid (bright regions in FIG. 8A, left) domains. As expected from the single-component lipid imaging (FIG. 8B), the gel domains within the SMOLM maps have larger polar angles and similar solid angles but a broader distribution (FIG. 8A, center left and center right) than liquid domains. The size and shape of resolved gel and liquid phases in the phase-index map (FIG. 8A, right) match those in the SMLM image (FIG. 8A, left), which is further demonstrated by line profiles of selected Lo domains (green regions 1 and 2 in FIG. 8A, left). The phase-index profiles are in good agreement with the profiles of SMLM images for both >1 μm (FIG. 8C, left) and ˜200 nm (FIG. 8C, center left) Lo domains. We also plotted the histogram of solid angles (FIG. 8D, left) and polar angles (FIG. 8D, right) from all localizations within the gel and liquid phases in region 1. The gel phase exhibits an additional population of MC540 with ˜70° polar angle and a small population of zero sr solid angle, which matches the orientation spectra observed in single-component DPPC SLBs (FIG. 8B).

Following MC540 imaging, we gently washed the sample with buffer and performed SMOLM imaging using Nile red. The polar angles of Nile red within gel and liquid phases are less resolvable from one another than those of MC540, therefore producing a lower-quality phase-index map (FIG. 8E, right). Some gel domain features are missing compared to MC540 SMOLM images (FIG. 8A, right) and conventional SMLM images (FIG. 8E, left). In addition, the phase-index line profile does not match the SMLM profile (blue and gray profiles in FIG. 8G), and the solid and polar angle histograms of gel and liquid phases (FIG. 8H) are indistinguishable. Therefore, MC540 discriminates gel versus liquid domains better than NR does in SMOLM.

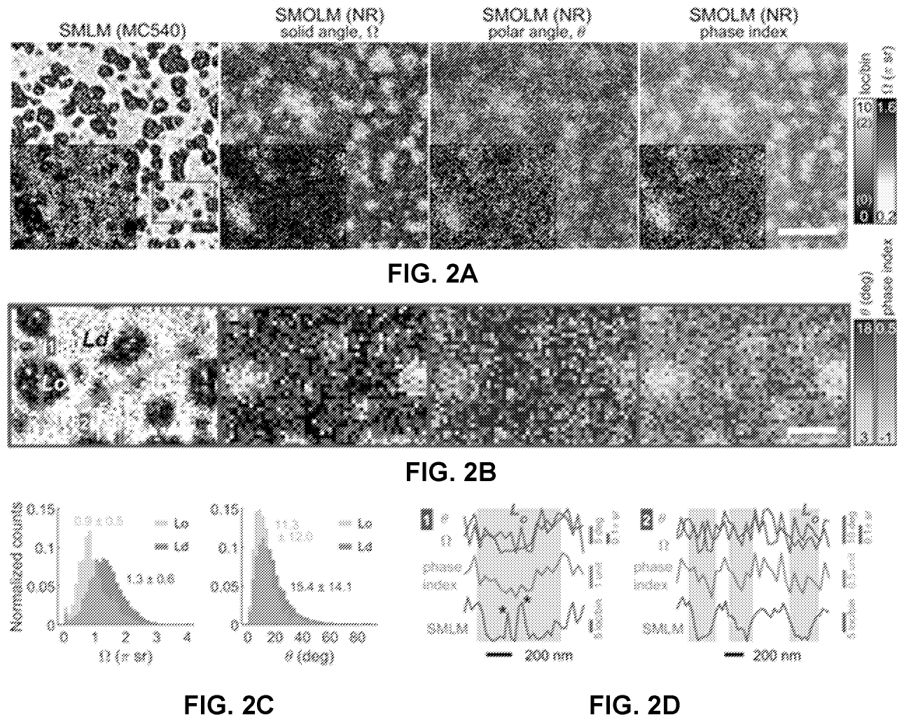

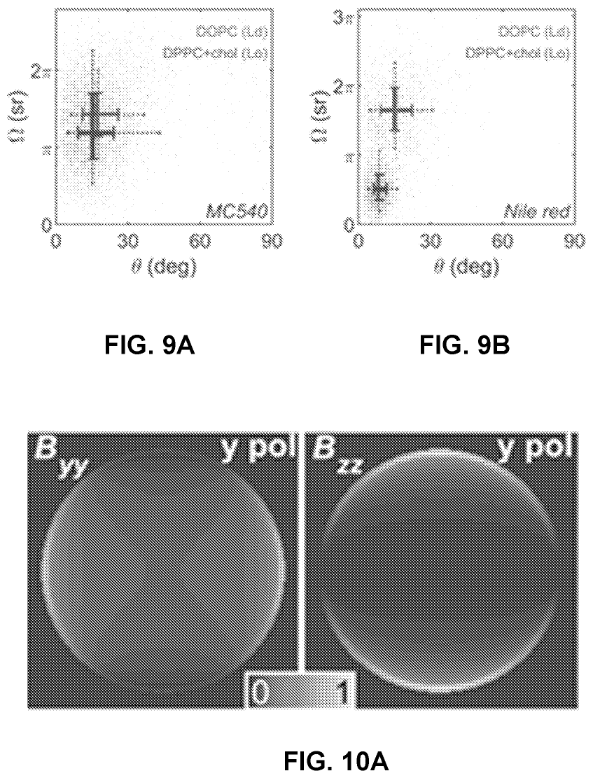

A second example is to characterize how MC540 and NR recognize Lo and La phases in a lipid mixture containing chol, such as DOPC/DPPC/chol. In such a mixture, chol is concentrated within DPPC domains to form the Lₒ phase, and DOPC forms the La phase. We measured the orientation spectra of Nile red and MC540 in a single-phase DPPC+chol (Lₒ) SLB and a DOPC (L_{d}) SLB (FIGS. 9A and 9B). Chol greatly reduces the polar angle of MC540 in the Lₒ phase and makes it hardly distinguishable (Δθ_{DPPC-DOPC}=2.3°, ΔΩ_{DPPC-DOPC}=0.23π sr) from that in the La phase (FIG. 9A, compared to FIG. 8B). Conversely, both the polar and solid angles of Nile red are well separated (Δθ_{DPPC-DOPC}=6.4°, ΔΩ_{DPPC-DOPC}=1.1371 sr) in Lo vs. Ld phases (FIG. 9B, compared to FIG. 8F). The data indicate Nile red is superior to MC540 in distinguishing Ld versus Lo domains. We therefore use Nile red for SMOLM imaging on DOPC/DPPC/chol and DOPC/SPM/chol lipid membranes as shown in FIG. 2 and FIG. 3 in the main text.

The observations and discussions above emphasize the importance of choosing fluorescence probes with the most separable orientation spectra in order to achieve well-resolved SMOLM imaging of lipid phase, composition, and/or packing.

However, in the presence of chol, our data indicate NR has superior performance to MC540 in distinguishing Lₒ and L_{d} domains. Next, one must choose a PSF that balances signal-to-background ratio (SBR), and therefore SM detection, with orientation sensitivity, i.e., the ability to resolve various orientational motions unambiguously. Due to varying measurement sensitivities, low SBRs, and tuning of analysis algorithms, different PSFs may perceive identical orientation spectra differently. However, these effects may be mitigated via instrument calibration.

SMOLM relies on optimized orientation-sensitive PSFs to precisely measure orientation spectra and discover structural and chemical details of the sample under study. Fundamentally, to measure orientation with high sensitivity, the photons from each SM must be spread across multiple snapshots or camera pixels, thereby lowering the signal-to-background ratio (SBR) compared to conventional SMLM. Furthermore, the rotational motions of fluorescent molecules are often accompanied by translational motions (diffusion), all of which are critical parameters to disentangle when probing molecular interactions in complex soft matter systems. Therefore, designing compact PSFs that can discriminate between translational and rotational diffusion, combined with modulation of the polarization of excitation light, could further improve SMOLM's spatiotemporal resolution for capturing faster biological processes. Similarly, the development of new image analysis algorithms based upon machine learning could also improve SMOLM's performance. We anticipate that SMOLM will enable high throughput studies of both translational and orientational dynamics of single fluorescent probes within various soft matter systems, facilitate the discovery of mechanisms that control the orientation of individual molecules, and promote the design of new probes whose orientation conveys improved sensitivity and specificity for sensing various biophysical and biochemical phenomena.

### Computing Systems and Devices

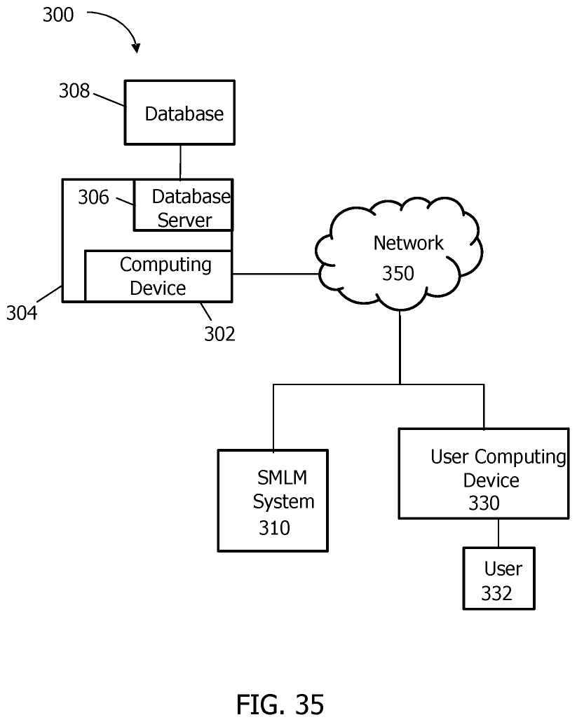

FIG. 35 depicts a simplified block diagram of a computing device for implementing the methods described herein. As illustrated in FIG. 35, the computing device 300 may be configured to implement at least a portion of the tasks associated with the disclosed method using the SMLM system 310 including, but not limited to: operating the system 310 to obtain single-molecule localization microscopy (SMLM) images. The computer system 300 may include a computing device 302. In one aspect, the computing device 302 is part of a server system 304, which also includes a database server 306. The computing device 302 is in communication with a database 308 through the database server 306. The computing device 302 is communicably coupled to the SMLM system 310 and a user computing device 330 through a network 350. The network 350 may be any network that allows local area or wide area communication between the devices. For example, the network 350 may allow communicative coupling to the Internet through at least one of many interfaces including, but not limited to, at least one of a network, such as the Internet, a local area network (LAN), a wide area network (WAN), an integrated services digital network (ISDN), a dial-up-connection, a digital subscriber line (DSL), a cellular phone connection, and a cable modem. The user computing device 330 may be any device capable of accessing the Internet including, but not limited to, a desktop computer, a laptop computer, a personal digital assistant (PDA), a cellular phone, a smartphone, a tablet, a phablet, wearable electronics, smartwatch, or other web-based connectable equipment or mobile devices.

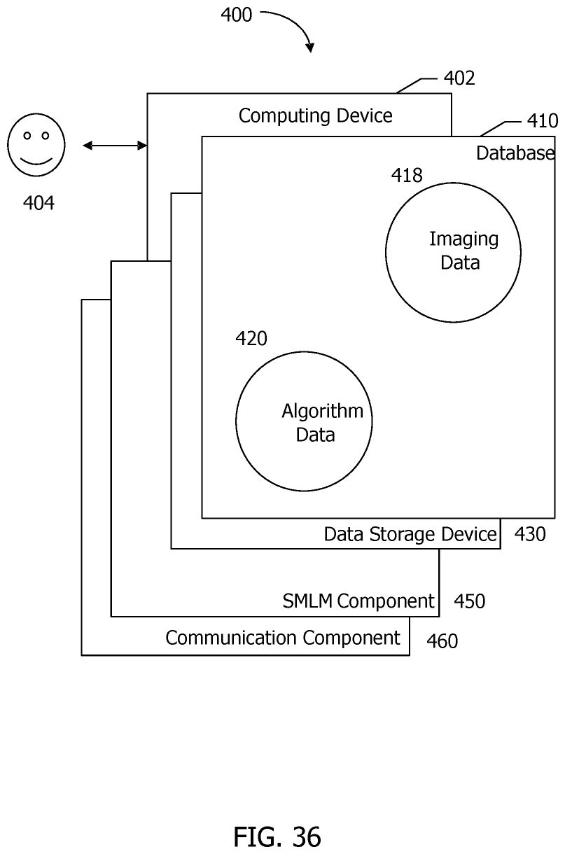

In other aspects, the computing device 302 is configured to perform a plurality of tasks associated with obtaining SMLM images. FIG. 36 depicts a component configuration 400 of computing device 402, which includes database 410 along with other related computing components. In some aspects, computing device 402 is similar to computing device 302 (shown in FIG. 35). A user 404 may access components of computing device 402. In some aspects, database 410 is similar to database 308 (shown in FIG. 35).

In one aspect, database 410 includes SMLM imaging data 418 and algorithm data 420. Non-limiting examples of suitable algorithm data 420 include any values of parameters defining the analysis of SMLM imaging data, such as any of the parameters from the equations described above.

Computing device 402 also includes a number of components that perform specific tasks. In the exemplary aspect, computing device 402 includes data storage device 430, SMLM component 450, and communication component 460. Data storage device 430 is configured to store data received or generated by computing device 402, such as any of the data stored in database 410 or any outputs of processes implemented by any component of computing device 402. SMLM component 450 is configured to operate or produce signals configured to operate, a SMLM device to obtain SMLM data, and to reconstruct the SMLM image based on the SMLM data.

Communication component 460 is configured to enable communications between computing device 402 and other devices (e.g. user computing device 330 and IMRT system 310, shown in FIG. 35) over a network, such as network 350 (shown in FIG. 35), or a plurality of network connections using predefined network protocols such as TCP/IP (Transmission Control Protocol/Internet Protocol).

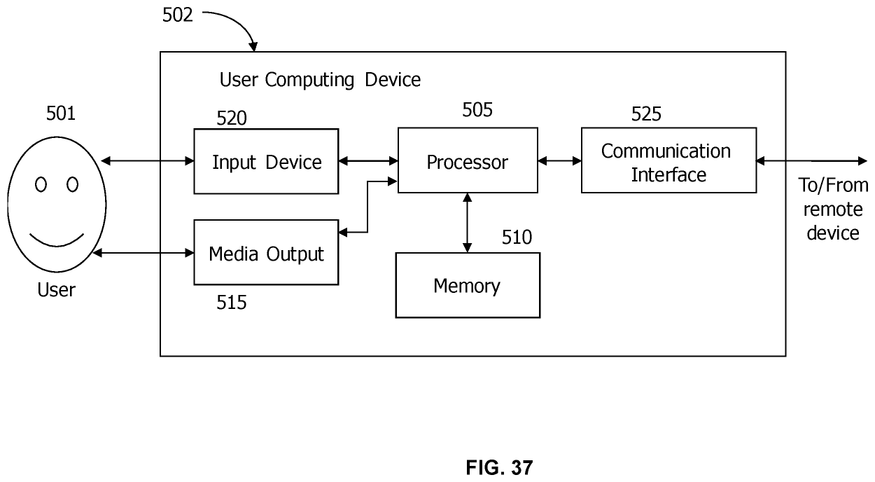

FIG. 37 depicts a configuration of a remote or user computing device 502, such as user computing device 330 (shown in FIG. 35). Computing device 502 may include a processor 505 for executing instructions. In some aspects, executable instructions may be stored in a memory area 510. Processor 505 may include one or more processing units (e.g., in a multi-core configuration). Memory area 510 may be any device allowing information such as executable instructions and/or other data to be stored and retrieved. Memory area 510 may include one or more computer-readable media.

Computing device 502 may also include at least one media output component 515 for presenting information to a user 501. Media output component 515 may be any component capable of conveying information to user 501. In some aspects, media output component 515 may include an output adapter, such as a video adapter and/or an audio adapter. An output adapter may be operatively coupled to processor 505 and operatively couplable to an output device such as a display device (e.g., a liquid crystal display (LCD), organic light-emitting diode (OLED) display, cathode ray tube (CRT), or “electronic ink” display) or an audio output device (e.g., a speaker or headphones). In some aspects, media output component 515 may be configured to present an interactive user interface (e.g., a web browser or client application) to user 501.

In some aspects, computing device 502 may include an input device 520 for receiving input from user 501. Input device 520 may include, for example, a keyboard, a pointing device, a mouse, a stylus, a touch-sensitive panel (e.g., a touchpad or a touch screen), a camera, a gyroscope, an accelerometer, a position detector, and/or an audio input device. A single component such as a touch screen may function as both an output device of media output component 515 and input device 520.

Computing device 502 may also include a communication interface 525, which may be communicatively couplable to a remote device. Communication interface 525 may include, for example, a wired or wireless network adapter or a wireless data transceiver for use with a mobile phone network (e.g., Global System for Mobile communications (GSM), 3G, 4G or Bluetooth) or other mobile data network (e.g., Worldwide Interoperability for Microwave Access (WIMAX)).

Stored in memory area 510 are, for example, computer-readable instructions for providing a user interface to user 501 via media output component 515 and, optionally, receiving and processing input from input device 520. A user interface may include, among other possibilities, a web browser and client application. Web browsers enable users 501 to display and interact with media and other information typically embedded on a web page or a website from a web server. A client application allows users 501 to interact with a server application associated with, for example, a vendor or business.

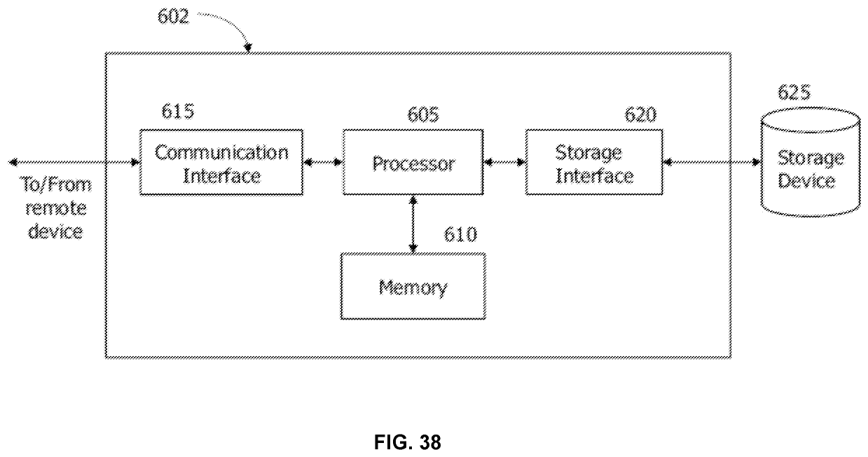

FIG. 38 illustrates an example configuration of a server system 602. Server system 602 may include, but is not limited to, database server 306 and computing device 302 (both shown in FIG. 35). In some aspects, server system 602 is similar to server system 304 (shown in FIG. 35). Server system 602 may include a processor 605 for executing instructions. Instructions may be stored in a memory area 625, for example. Processor 605 may include one or more processing units (e.g., in a multi-core configuration).

Processor 605 may be operatively coupled to a communication interface 615 such that server system 602 may be capable of communicating with a remote device such as user computing device 330 (shown in FIG. 35) or another server system 602. For example, communication interface 615 may receive requests from user computing device 330 via a network 350 (shown in FIG. 35).

Processor 605 may also be operatively coupled to a storage device 625. Storage device 625 may be any computer-operated hardware suitable for storing and/or retrieving data. In some aspects, storage device 625 may be integrated into server system 602. For example, server system 602 may include one or more hard disk drives as storage device 625. In other aspects, storage device 625 may be external to server system 602 and may be accessed by a plurality of server systems 602. For example, storage device 625 may include multiple storage units such as hard disks or solid-state disks in a redundant array of inexpensive disks (RAID) configuration. Storage device 625 may include a storage area network (SAN) and/or a network attached storage (NAS) system.

In some aspects, processor 605 may be operatively coupled to storage device 625 via a storage interface 620. Storage interface 620 may be any component capable of providing processor 605 with access to storage device 625. Storage interface 620 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 605 with access to storage device 625.

Memory areas 510 (shown in FIG. 37) and 610 may include, but are not limited to, random access memory (RAM) such as dynamic RAM (DRAM) or static RAM (SRAM), read-only memory (ROM), erasable programmable read-only memory (EPROM), electrically erasable programmable read-only memory (EEPROM), and non-volatile RAM (NVRAM). The above memory types are example only, and are thus not limiting as to the types of memory usable for storage of a computer program.

The computer systems and computer-implemented methods discussed herein may include additional, less, or alternate actions and/or functionalities, including those discussed elsewhere herein. The computer systems may include or be implemented via computer-executable instructions stored on non-transitory computer-readable media. The methods may be implemented via one or more local or remote processors, transceivers, servers, and/or sensors (such as processors, transceivers, servers, and/or sensors mounted on vehicle or mobile devices, or associated with smart infrastructure or remote servers), and/or via computer-executable instructions stored on non-transitory computer-readable media or medium.

In some aspects, a computing device is configured to implement machine learning, such that the computing device “learns” to analyze, organize, and/or process data without being explicitly programmed. Machine learning may be implemented through machine learning (ML) methods and algorithms. In one aspect, a machine learning (ML) module is configured to implement ML methods and algorithms. In some aspects, ML methods and algorithms are applied to data inputs and generate machine learning (ML) outputs. Data inputs may further include: sensor data, image data, video data, telematics data, authentication data, authorization data, security data, mobile device data, geolocation information, transaction data, personal identification data, financial data, usage data, weather pattern data, “big data” sets, and/or user preference data. In some aspects, data inputs may include certain ML outputs.

In some aspects, at least one of a plurality of ML methods and algorithms may be applied, which may include but are not limited to: linear or logistic regression, instance-based algorithms, regularization algorithms, decision trees, Bayesian networks, cluster analysis, association rule learning, artificial neural networks, deep learning, dimensionality reduction, and support vector machines. In various aspects, the implemented ML methods and algorithms are directed toward at least one of a plurality of categorizations of machine learning, such as supervised learning, unsupervised learning, and reinforcement learning.

In one aspect, ML methods and algorithms are directed toward supervised learning, which involves identifying patterns in existing data to make predictions about subsequently received data. Specifically, ML methods and algorithms directed toward supervised learning are “trained” through training data, which includes example inputs and associated example outputs. Based on the training data, the ML methods and algorithms may generate a predictive function that maps outputs to inputs and utilize the predictive function to generate ML outputs based on data inputs. The example inputs and example outputs of the training data may include any of the data inputs or ML outputs described above.

In another aspect, ML methods and algorithms are directed toward unsupervised learning, which involves finding meaningful relationships in unorganized data. Unlike supervised learning, unsupervised learning does not involve user-initiated training based on example inputs with associated outputs. Rather, in unsupervised learning, unlabeled data, which may be any combination of data inputs and/or ML outputs as described above, is organized according to an algorithm-determined relationship.

In yet another aspect, ML methods and algorithms are directed toward reinforcement learning, which involves optimizing outputs based on feedback from a reward signal. Specifically, ML methods and algorithms directed toward reinforcement learning may receive a user-defined reward signal definition, receive data input, utilize a decision-making model to generate an ML output based on the data input, receive a reward signal based on the reward signal definition and the ML output, and alter the decision-making model so as to receive a stronger reward signal for subsequently generated ML outputs. The reward signal definition may be based on any of the data inputs or ML outputs described above. In one aspect, an ML module implements reinforcement learning in a user recommendation application. The ML module may utilize a decision-making model to generate a ranked list of options based on user information received from the user and may further receive selection data based on a user selection of one of the ranked options. A reward signal may be generated based on comparing the selection data to the ranking of the selected option. The ML module may update the decision-making model such that subsequently generated rankings more accurately predict a user selection.

As will be appreciated based upon the foregoing specification, the above-described aspects of the disclosure may be implemented using computer programming or engineering techniques including computer software, firmware, hardware, or any combination or subset thereof. Any such resulting program, having computer-readable code means, may be embodied or provided within one or more computer-readable media, thereby making a computer program product, i.e., an article of manufacture, according to the discussed aspects of the disclosure. The computer-readable media may be, for example, but is not limited to, a fixed (hard) drive, diskette, optical disk, magnetic tape, semiconductor memory such as read-only memory (ROM), and/or any transmitting/receiving media, such as the Internet or other communication network or link. The article of manufacture containing the computer code may be made and/or used by executing the code directly from one medium, by copying the code from one medium to another medium, or by transmitting the code over a network.

These computer programs (also known as programs, software, software applications, “apps”, or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus, and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The “machine-readable medium” and “computer-readable medium,” however, do not include transitory signals. The term “machine-readable signal” refers to any signal used to provide machine instructions and/or data to a programmable processor.

As used herein, a processor may include any programmable system including systems using micro-controllers, reduced instruction set circuits (RISC), application specific integrated circuits (ASICs), logic circuits, and any other circuit or processor capable of executing the functions described herein. The above examples are examples only, and are thus not intended to limit in any way the definition and/or meaning of the term “processor.”

As used herein, the terms “software” and “firmware” are interchangeable and include any computer program stored in memory for execution by a processor, including RAM memory, ROM memory, EPROM memory, EEPROM memory, and non-volatile RAM (NVRAM) memory. The above memory types are example only, and are thus not limiting as to the types of memory usable for storage of a computer program.

In one aspect, a computer program is provided, and the program is embodied on a computer-readable medium. In one aspect, the system is executed on a single computer system, without requiring a connection to a server computer. In a further aspect, the system is being run in a Windows® environment (Windows is a registered trademark of Microsoft Corporation, Redmond, Wash.). In yet another aspect, the system is run on a mainframe environment and a UNIX® server environment (UNIX is a registered trademark of X/Open Company Limited located in Reading, Berkshire, United Kingdom). The application is flexible and designed to run in various different environments without compromising any major functionality.

In some aspects, the system includes multiple components distributed among a plurality of computing devices. One or more components may be in the form of computer-executable instructions embodied in a computer-readable medium. The systems and processes are not limited to the specific aspects described herein. In addition, components of each system and each process can be practiced independently and separate from other components and processes described herein. Each component and process can also be used in combination with other assembly packages and processes. The present aspects may enhance the functionality and functioning of computers and/or computer systems.

Definitions and methods described herein are provided to better define the present disclosure and to guide those of ordinary skill in the art in the practice of the present disclosure. Unless otherwise noted, terms are to be understood according to conventional usage by those of ordinary skill in the relevant art.

In some embodiments, numbers expressing quantities of ingredients, properties such as molecular weight, reaction conditions, and so forth, used to describe and claim certain embodiments of the present disclosure are to be understood as being modified in some instances by the term “about.” In some embodiments, the term “about” is used to indicate that a value includes the standard deviation of the mean for the device or method being employed to determine the value. In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the present disclosure are approximations, the numerical values set forth in the specific examples are reported as precisely as practicable. The numerical values presented in some embodiments of the present disclosure may contain certain errors necessarily resulting from the standard deviation found in their respective testing measurements. The recitation of ranges of values herein is merely intended to serve as a shorthand method of referring individually to each separate value falling within the range. Unless otherwise indicated herein, each individual value is incorporated into the specification as if it were individually recited herein. The recitation of discrete values is understood to include ranges between each value.

In some embodiments, the terms “a” and “an” and “the” and similar references used in the context of describing a particular embodiment (especially in the context of certain of the following claims) can be construed to cover both the singular and the plural, unless specifically noted otherwise. In some embodiments, the term “or” as used herein, including the claims, is used to mean “and/or” unless explicitly indicated to refer to alternatives only or the alternatives are mutually exclusive.

The terms “comprise,” “have” and “include” are open-ended linking verbs. Any forms or tenses of one or more of these verbs, such as “comprises,” “comprising,” “has,” “having,” “includes” and “including,” are also open-ended. For example, any method that “comprises,” “has” or “includes” one or more steps is not limited to possessing only those one or more steps and can also cover other unlisted steps. Similarly, any composition or device that “comprises,” “has” or “includes” one or more features is not limited to possessing only those one or more features and can cover other unlisted features.

All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the present disclosure and does not pose a limitation on the scope of the present disclosure otherwise claimed. No language in the specification should be construed as indicating any non-claimed element essential to the practice of the present disclosure.

Groupings of alternative elements or embodiments of the present disclosure disclosed herein are not to be construed as limitations. Each group member can be referred to and claimed individually or in any combination with other members of the group or other elements found herein. One or more members of a group can be included in, or deleted from, a group for reasons of convenience or patentability. When any such inclusion or deletion occurs, the specification is herein deemed to contain the group as modified thus fulfilling the written description of all Markush groups used in the appended claims.

Any publications, patents, patent applications, and other references cited in this application are incorporated herein by reference in their entirety for all purposes to the same extent as if each individual publication, patent, patent application, or other reference was specifically and individually indicated to be incorporated by reference in its entirety for all purposes. Citation of a reference herein shall not be construed as an admission that such is prior art to the present disclosure.

Having described the present disclosure in detail, it will be apparent that modifications, variations, and equivalent embodiments are possible without departing the scope of the present disclosure defined in the appended claims. Furthermore, it should be appreciated that all examples in the present disclosure are provided as non-limiting examples.

### EXAMPLES

The following examples illustrate various aspects of the disclosure.

### EXAMPLES

For the examples described below, the following materials were used: 1,2-dipalmitoyl-sn-glycero-3-phosphocholine (DPPC, 850355), 1,2-dioleoyl-sn-glycero-3-phosphocholine (DOPC, 850375), 1-palmitoyl-2-oleoyl-glycero-3-phosphocholine (POPC, 850457), N-palmitoyl-D-erythro-sphingosine (ceramide, 860516) were purchased from Avanti Polar Lipids. Cholesterol (C8667), cholesterol-methyl-β-cyclodextrin (MDCD-chol, C4951), melatonin (M5250), N-palmitoyl-D-sphingomyelin (SPM, 91553), sphingomyelinase (57651), Nile Blue (370088), glucose (G8270), glucose oxidase (G2133), catalase (C100), sodium chloride (59625), Trizma base (T1503), hydrochloric acid (320331) were purchased from Sigma-Aldrich. Merocyanine 540 (M24571), Nile Red (AC415711000), DiI-C18(5) (D3911), carboxylate-modified microspheres (0.1 μm, 350/440 blue fluorescent, F8797) were purchased from Thermo Fisher Scientific. Deionized water (>18 MΩ·cm) was obtained through a Milli-Q water purification system and used for all aqueous solutions. High precision cover glass (No. 1.5H, thickness 170 μm±5 μm, 22×22 mm, Marienfeld) was used for all imaging.

For the examples described below, the following imaging buffers were used: Tris buffer: 100 mM NaCl, 10 mM Tris, pH 7.4. GLOX buffer: 50 mM Tris (pH 8.3), 10 mM NaCl, 10% (w/v) glucose, and 1% (v/v) enzymatic oxygen scavenger system. The stock solution of the enzymatic oxygen scavenger system was prepared by adding 8 mg glucose oxidase and 38 μL 21 mg/mL catalase into 160 μL PBS, followed by 1 min 15,000 rpm centrifuging. The precipitate was removed before use.

For the examples described below, supported lipid bilayers (SLB) were formed by fusing vesicles on coverslips. To prepare large unilamellar vesicles (LUVs), a lipid mixture was first dissolved in chloroform, followed by evaporation of the solvent and drying for over 12 h under vacuum. The lipids were resuspended by adding Tris buffer (100 mM NaCl, 3 mM Ca²⁺, 10 mM Tris, pH 7.4) to arrive at a final lipid concentration of 1 mM. The lipid suspension was vigorously vortexed for 30 min under nitrogen before extrusion (25 passages, Avanti Polar Lipids). The monodisperse LUVs were next added onto ozone-cleaned (UV Ozone Cleaner, Novascan Technologies) coverslips and incubated in a water bath at a temperature higher than the phase transition temperature of the lipids for 1 hour to form an SLB. After 30 min of cooling to room temperature, the lipid bilayer was thoroughly rinsed with Tris buffer to remove residual lipids and imaged immediately. To track the possible shift of coverslip during super-resolution imaging, a layer of fluorescent beads (0.1 μm, blue fluorescent, 1:2000 dilution in H₂O) was sparsely spin-coated (2500 rpm for 40 s) on the coverslip before the deposition of the SLB.

### Example 1: SMOLM Imaging Using Duo-Spot PSF

A new orientation-sensitive PSF, called the Duo-spot PSF, was developed for improved SNR and SM detectability at the low photon levels observed in this study.

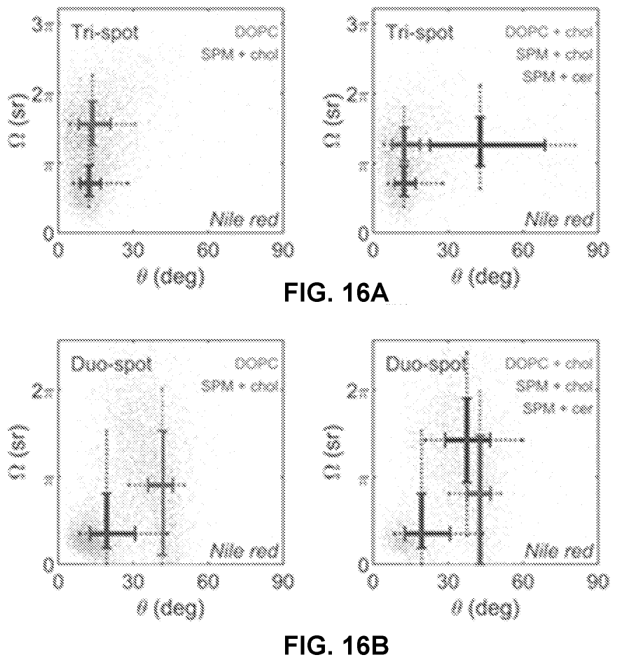

We confirmed that NR SMOLM imaging using the Duo-spot PSF has excellent sensitivity for distinguishing newly generated ceramide domains vs. chol-rich Lo domains in static single-phase lipid samples. In the lipid mixture of DOPC/SPM/chol after SMase treatment, three different phases could coexist: a DOPC (or DOPC+chol) Ld phase, an SPM+chol Lo phase, and an SPM+cer Lo phase. The orientation spectra of Nile red are able to distinguish these three phases in single-phase samples (FIG. 16B). In order to generate phase-index maps in mixed samples, we applied support vector machines (SVM) and kernel principal component analysis (KPCA) to conduct non-linear dimensionality reduction on the SMOLM data (polar angle θ and solid angle Ω) via the following procedures:²²

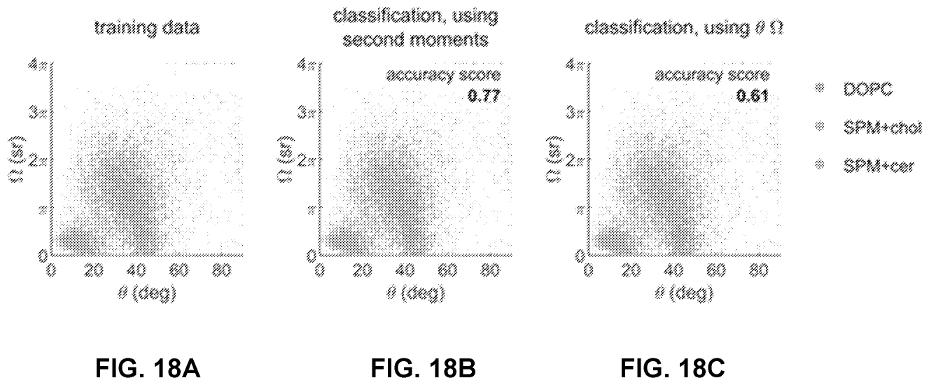

1). Use SMOLM data of single-phase lipid samples (DOPC SLB, SPM+chol SLB, and SPM+cer SLB) as training data to fit the SVM model. The performance of SVM model fitting was tested by performing classification on the same training data. We found that using the six orientational second moments instead of polar and solid angles from SMOLM produced higher accuracy scores and better classification results (FIG. 18). We therefore used the second moment estimates from our maximum likelihood estimator for all SVM and KPCA analyses.

2). Use the SVM model to classify the SMOLM results of DOPC/SPM/chol after SMase treatment (t₃ in FIG. 3) into three classes (DOPC, SPM+chol, SPM+cer). The purpose of this step is to classify and label the experimental data, and select balanced data from three phases to fit the KPCA model in the next step.

3). Select equal numbers (11833 data points for each class) of data points from the three classes in step 2, and fit to a KPCA model (using rbf kernel).

4). Apply this KPCA model in step 3 to transform the entire SMOLM dataset (t₀,t₁,t₂,t₃ in FIG. 3), and use the KPCA score of the first component as the SMOLM phase index.

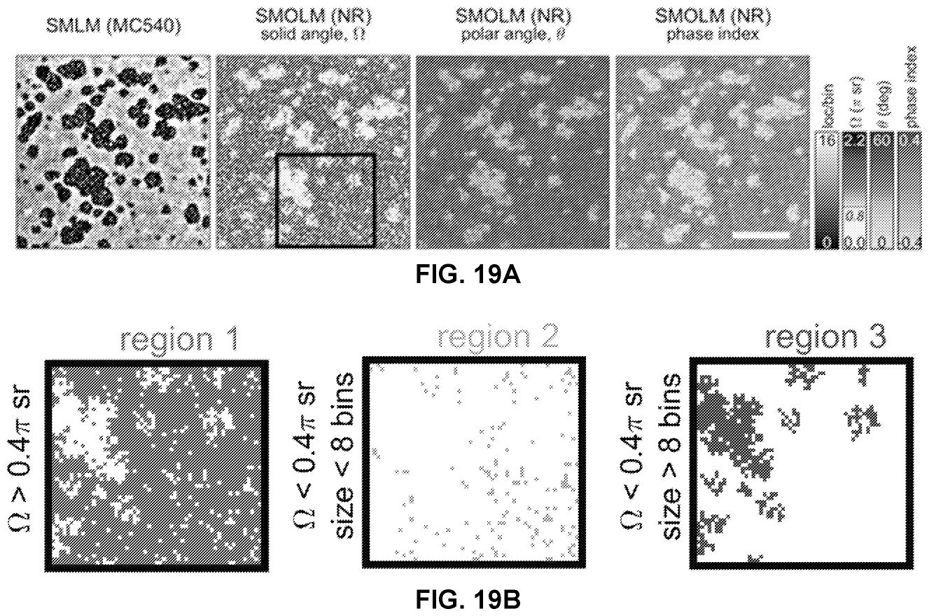

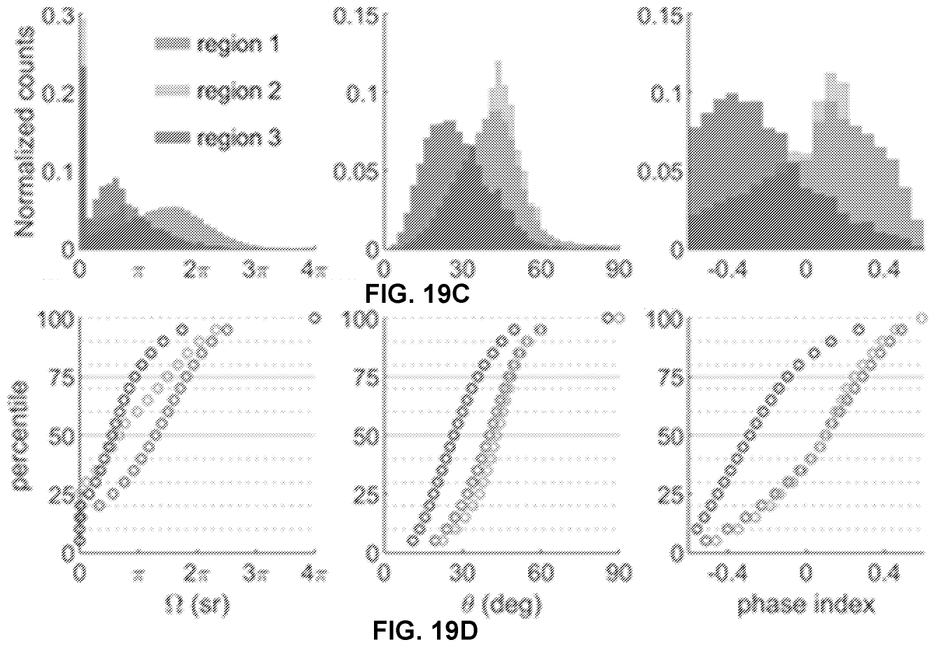

The SMOLM phase-index maps (FIGS. 3, 19A (right), and 20B) during SMase treatment were all generated using the above procedures.

When using the Tri-spot PSF, we use the median value of the localizations in each bin to generate the SMOLM maps (polar angle map, solid angle map, and phase-index map), as stated in the Methods section. However, when using this same criterion for orientation spectra captured by the Duo-spot PSF, we noticed that many “small-sized” Lo regions with small solid angles appear in SMOLM solid angle maps (FIG. 19A (center left), and FIG. 19B (center)). These discrepancies in the SMOLM maps are caused by variations in the orientation spectra measured by the Duo-spot and Tri-spot PSFs (FIGS. 15A and 15B).

To analyze these regions in more detail, we applied Q and object size thresholds to create three regions (magnified view in FIG. 19B). Region 1 contains all bins with Ω>0.8π sr (median value in Lo phase). Region 3 contains large objects (object size >8 contiguously connected bins) with Ω≤0.8π sr. We assign the remaining bins to Region 2 which contains relatively sparse and small objects (object size ≤8 bins) with small Ω (≤0.8π sr). We analyze the polar angle, solid angle, and phase index from all localizations within each region (FIG. 19B). The distribution of phase index (FIG. 19C (right)) and polar angle (FIG. 19C (center)) show that regions 1 and 2 contain lipids in the Ld phase; their distributions of polar angle and phase index all overlap one another. Conversely, these data suggest that region 3 belongs to the Lo phase.

However, the solid angle histogram (FIG. 19C (left)) indicates that region 2 contains populations of both small Q (as in region 3) and large Q (as in region 1). As shown in FIG. 19D (left), for percentiles below 55, region 2 appears to be the same phase as region 3 (Lo phase), which is inconsistent with the polar angle and phase-index data (FIG. 19D (center, right)). In contrast, the solid angles at the 75^{th} percentile or above for regions 1 and 2 are in good agreement. Therefore, we chose the 75^{th} percentile to represent the SMOLM maps of solid angle and polar angle for all Duo-spot PSF measurements, while keep using the 50^{th} percentile for the phase-index map. This choice creates consistent visualizations of Lo and Ld domains in all SMOLM maps (FIG. 3B).

We calculated the phase-index of the training data (single-phase lipid samples, FIG. 16B), including SPM+chol, SPM+cer, DOPC, and DOPC+chol, using the procedures above. The results are summarized in Table 1.

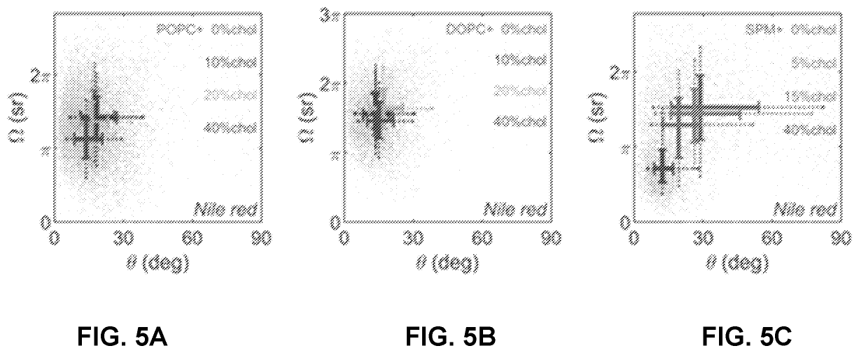

Nile red in SPM+chol (Lo phase) exhibits small polar and solid angles with negative phase indices (Table 1). Both the orientation spectra (polar and wobble angles) and phase index increase as the lipid composition changes to a SPM+cer Lo phase (Table 1). Therefore, Nile red SMOLM imaging has excellent sensitivity to distinguish the conversion from chol-rich to ceramide-rich Lo domains. In Ld phases (DOPC or DOPC+chol), the ordering effect of chol is weak. The addition of chol does not have a significant impact on the observed Nile red orientation spectra and phase indices (Table 1), which is similar to observations using the Tri-spot PSF in FIG. 5B. Therefore, we do not discriminate between DOPC and DOPC+chol domains when imaging enzyme-mediated changes to lipid composition.

TABLE 1
SMOLM measurements of the orientation (polar angle, θ), wobble (solid angle, Ω),
and phase index (median ± std) of Nile red in single-phase lipid samples using the Duo-spot PSF.

| | Single-phase lipid sample | | | |
|---|---|---|---|---|
| | SPM + chol SLB | SPM + cer SLB | DOPC SLB | DOPC + chol SLB |
| Polar angle, θ (deg) | 19.4 ± 14.1 | 37.5 ± 15.7 | 41.5 ± 8.5 | 42.8 ± 8.0 |
| Solid angle, Ω (π sr) | 0.35 ± 0.58 | 1.42 ± 0.74 | 0.91 ± 0.79 | 0.81 ± 0.78 |
| Phase-index (KPCA | 0.070 ± 0.302 | 0.042 ± 0.271 | 0.069 ± 0.258 | 0.080 ± 0.284 |
| score, arb. units) | | | | |

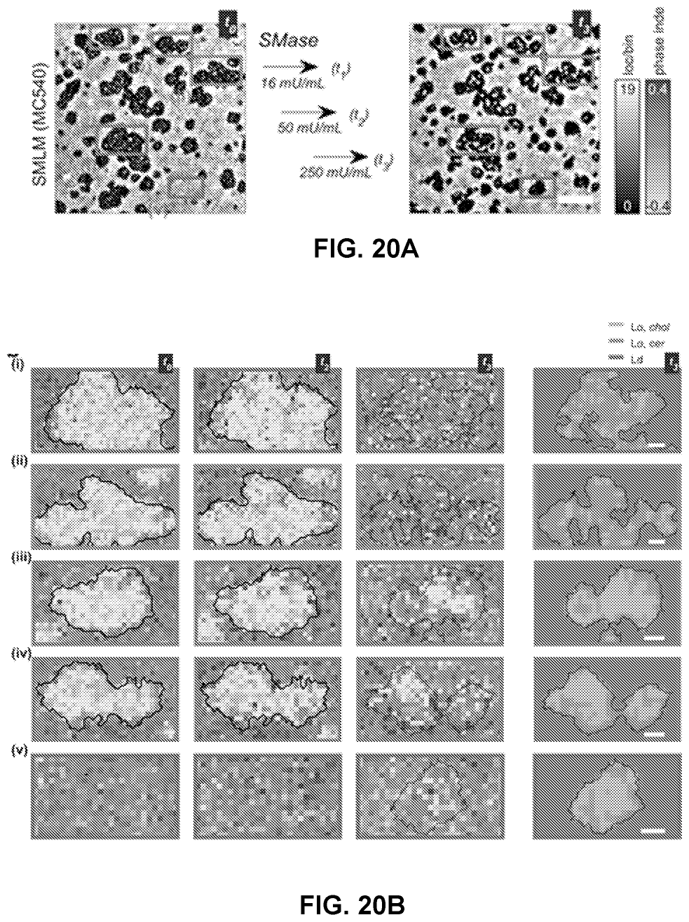

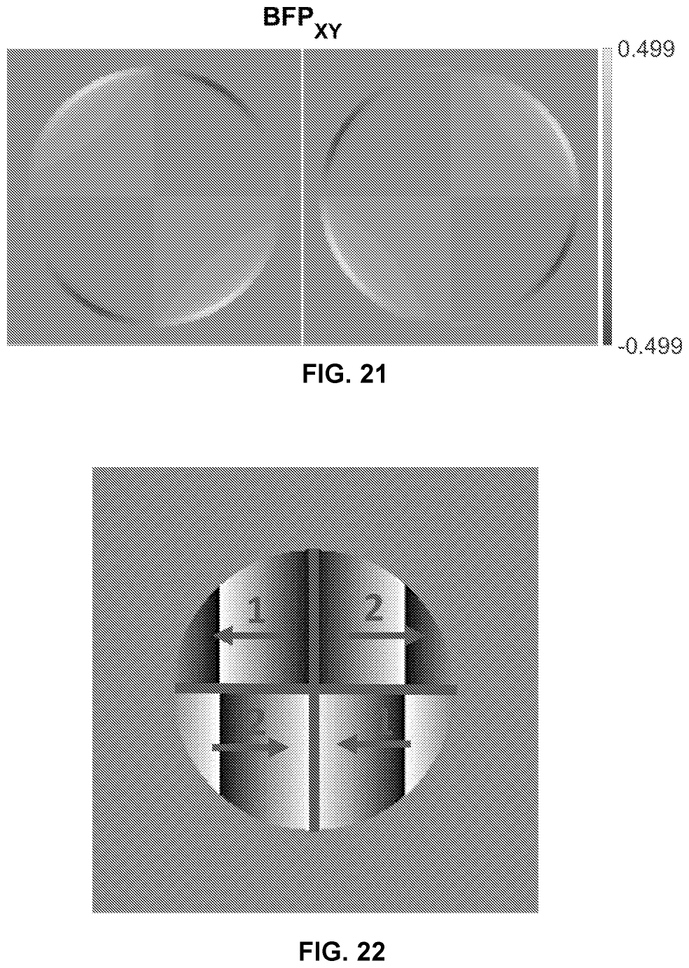

We further calculated the mean value of phase index in single-phase lipid samples of SPM+chol SLBs and SPM+cer SLBs. The midpoint between these means (−0.014, arb. units) was used to determine the phase-index threshold to separate the SPM+chol and SPM+cer phases in FIG. 3C (right), FIG. 3E (right), and FIG. 20B.

### Example 2: Effect of Molecular Lateral Diffusion on Single Molecule PSFs and Estimation of Orientation and Wobble

In the liquid phase, lipid acyl chains are kinked and loosely packed, causing fluorescence probes embedded within the lipid bilayer to diffuse rapidly (D=2˜5 μm²/s)¹⁸. This lateral diffusion results in an average 4×10²-7×10² nm (\sqrt{4Dt}) displacement within a 30-ms camera exposure time. This distance is of the same magnitude as the size of an optical PSF. Therefore lateral diffusion could distort the Tri-spot or Duo-spot PSF and potentially bias SMOLM orientation estimates.

To quantitatively understand how the diffusion-induced PSF distortion influences orientation estimation using different orientation-sensitive PSFs, we used a random walk to simulate the lateral trajectory of a single molecule within one camera frame and thus generate the PSF image. Brightness of 1365 photons and background of 11 photons/pixel were used to match our typical lipid imaging conditions. The lateral diffusion coefficients were set to 5 μm²/s and 0.005 μm²/s for liquid and gel phases, respectively. Each trajectory within one camera frame (30 ms) contains 100 steps of random walk, and for each set of ground truth polar angle θ, azimuth angle ϕ, and solid angle Ω, we simulated 100 independent camera frames. Finally, the orientation and wobble of simulated PSFs were estimated using the same maximum-likelihood estimation algorithm as used for analyzing experimental data.

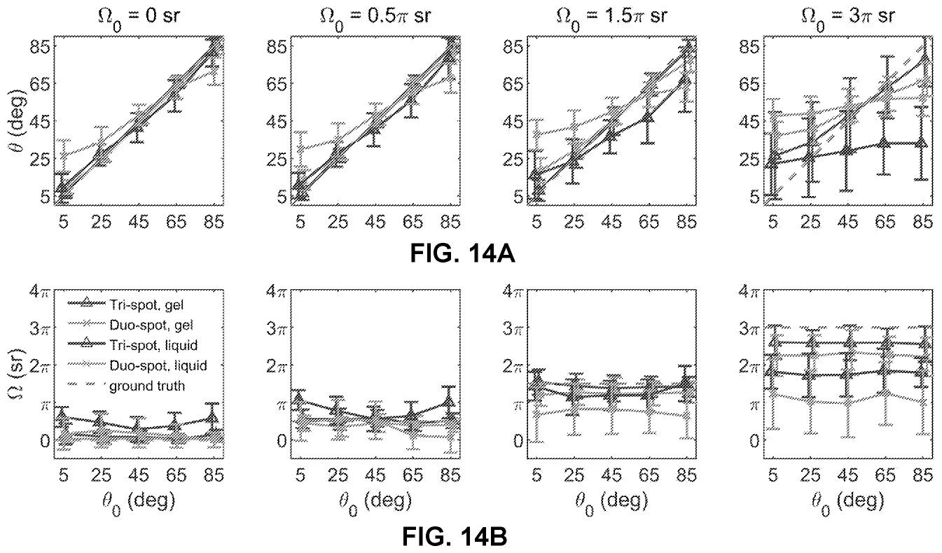

In the gel phase, the average lateral displacement of a single probe molecule within 30-ms camera exposure time is 25 nm (\sqrt{4}Dt). Our simulation results indicate that both the Tri-spot and Duo-spot PSFs show accurate orientation (polar angle and solid angle) estimates (blue and light blue plots in FIG. 14). In the liquid phase, however, the lateral diffusion-induced PSF distortion causes large biases of both PSFs (red and orange plots in FIG. 14). Especially for ground truth orientations with small polar angle (θ<5°) and wobble (Ω<0.5π sr), the polar angle was overestimated by up to 20 degrees using the Duo-spot PSF compared to the Tri-spot PSF.

Although the Duo-spot was rationally designed for measuring out-of-plane orientations precisely and its performance on orientation detection has been detailed characterized in the previous section, our simulation results indicate its performance is more easily affected by the lateral diffusion-induced PSF distortion in liquid phase of lipid bilayer than Tri-spot. Currently, we did not attempt to compensate for estimation bias caused by lateral diffusion within our maximum-likelihood estimation algorithm. Any orientation-sensitive PSFs used for SMOLM could suffer varying degrees of estimation bias due to fluorophore diffusion.

Although the Duo-spot was rationally designed for measuring out-of-plane orientations precisely and its performance on orientation detection has been detailed characterized in the previous section, our simulation results indicate its performance is more easily affected by the lateral diffusion-induced PSF distortion in liquid phase of lipid bilayer than Tri-spot. Currently, we did not attempt to compensate for estimation bias caused by lateral diffusion within our maximum-likelihood estimation algorithm. Any orientation-sensitive PSFs used for SMOLM could suffer varying degrees of estimation bias due to fluorophore diffusion.

Practically, in SMOLM lipid imaging, as long as the apparent orientation and wobble angles show separable changes and these changes can be interpreted using the measurements obtained from single-phase lipid samples, both the Duo-spot and Tri-spot PSF remain powerful tools for separating lipid domains and detecting the compositional alternations in the lipid membrane.

### Example 3: Comparison of the Duo-Spot Vs. Tri-Spot PSFs for SMOLM Imaging of DOPC SPM/Chol SLBs

For SMOLM imaging of mixed DOPC/SPM/chol SLBs (FIG. 3), we used the Duo-spot PSF due to its improved SBR over the Tri-spot PSF. Although the SMOLM images (polar angle map, solid angle map, and phase-index map) resolve the Lo/Ld domains well (FIG. 3), the measured or apparent orientation spectra using the Duo-spot PSF are different from those of the Tri-spot PSF. For identical SLB compositions of DOPC/SPM/chol (35:35:30, molar ratio), the measured polar angle of Nile red shows a significant difference when using the Tri-spot PSF (17.6±16.8°, median±std) vs. the Duo-spot PSF (40.0±12.9°), as shown in FIG. 15A. The measured wobble (solid angle) shows less variation between PSFs (FIG. 15B): 1.24π±0.61π sr (Tri-spot PSF) vs. 1.19π±0.81π sr (Duo-spot PSF).

The lipid mixture DOPC/SPM/chol contains both Lo and Ld phases with different lipid compositions and different diffusion coefficients. To better understand the observed discrepancies in FIG. 15, it is reasonable to compare the orientation spectra of Nile red in single-phase lipid samples, e.g. DOPC(+chol) SLB, SPM+chol SLB, and SPM+cer SLB.

In the single-phase lipid samples, minor differences were observed within the Nile red orientation spectra in SPM+chol and SPM+cer phases when comparing the Duo-spot (FIG. 16B, green and purple plots) to the Tri-spot PSF (FIG. 16A, green and purple plots). These phases have low diffusion coefficients (0.10±0.02 μm²/s for Lo phase¹⁹, 0.005 μm²/s for gel phase), and the molecules show small lateral displacement (<100 nm) within our typical camera exposure time. The estimated orientation and wobble using Tri-spot and Duo-spot approximately match each other, as shown in our simulations of diffusing molecules (FIG. 14).

However, within the DOPC Ld phase, major differences were observed in the estimated polar angle between the Tri-spot PSF (13.6±11.6°, FIG. 16A (left), pink plot) and the Duo-spot PSF (41.5±8.5°, FIG. 16B (left), pink plot). Similar differences were also observed in the DOPC+chol Ld phase (FIG. 16A (right) and FIG. 16B (right), pink plots). We therefore investigated how molecular diffusion affects the estimated orientation and wobble in DOPC(+chol) SLBs. For our simulations of diffusive molecules, we used the typical brightness, background, diffusion coefficient (5 μm²/s), and exposure time that match experimental conditions.

As shown in Table 2, for the molecule with a ground-truth orientation of 16° (polar angle) and wobble of 2π sr (solid angle) in DOPC Ld SLBs, the estimated polar angle when using the Tri-spot PSF from simulated images (13.6±6.0°) matches the experimental result (13.6±11.6°) very well. However, the Duo-spot simulation reports the polar angle as 33.2±8.23°, which is about 200 larger than that measured by the Tri-spot experimentally. Although our Duo-spot simulation does not perfectly match the measured experimental polar angle (41.5±8.5°), our simulations confirm that polar angles are more likely to be overestimated by using the Duo-spot PSF, compared to Tri-spot; this overestimate is likely caused by high lateral diffusion and PSF distortion in Ld phases. On the other hand, the estimated solid angle in simulated images (1.89π±0.10π sr) is much larger than experimental observations (0.91π±0.79π sr) for the Duo-spot PSF and is likely caused by some other form of imaging model-experimental mismatch. Similar simulation results were obtained for the DOPC+chol sample (Table 2); the Tri-spot PSF experimental measurements largely match those from simulated images of diffusive molecules, while the experimental orientation measurements using the Duo-spot PSF are systematically larger than those from simulated images. Although our simulations of laterally diffusing molecules partially explain discrepancies in the orientation spectra in single-phase lipid samples between the Duo-spot and Tri-spot PSFs, the orientation spectra are still well separable in DOPC(+chol), SPM+chol, and SPM+cer SLBs (FIG. 16). Therefore, both the Tri-spot and Duo-spot PSFs are able to distinguish reliably various lipid phases in lipid mixtures of DOPC/SPM/chol.

TABLE 2
Comparison of simulated and experimental SMOLM orientation measurements (polar
angle θ and wobble solid angle Ω) (median std) of laterally diffusing
Nile red in single-phase lipid samples using the Tri-spot and Duo-spot PSFs.

| | | Single-phase lipid sample | | | |
|---|---|---|---|---|---|
| | | DOPC SLB | | DOPC + chol SLB | |
| | | Polar angle, | Solid angle, | Polar angle, | Solid angle, |
| | | θ (deg) | Ω (π sr) | θ (deg) | Ω (π sr) |
| Ground truth for simulation | | 16 | 2 | 12 | 1.48 |
| Tri- | experiment | 13.6 ± 11.6 | 1.55 ± 0.48 | 12.3 ± 9.1 | 1.26 ± 0.39 |
| spot PSF | simulation | 13.6 ± 6.0 | 1.52 ± 0.02 | 13.0 ± 8.9 | 1.28 ± 0.02 |
| Duo- | experiment | 41.5 ± 8.5 | 0.91 ± 0.79 | 42.8 ± 8.0 | 0.81 ± 0.78 |
| spot PSF | simulation | 33.2 ± 8.3 | 1.89 ± 0.10 | 26.3 ± 8.1 | 1.68 ± 0.12 |

### Example 4: SMOLM Orientation Spectra of Lipophilic Dyes in Lipid Membranes

We developed SMOLM, single-molecule orientation localization microscopy, to directly measure the orientation spectra (3D orientation plus “wobble”) of lipophilic probes transiently bound to lipid membranes. SMOLM measurements reveal that Nile red's (NR) orientation spectra are extremely sensitive to the chemical composition of lipid membranes. SMOLM images resolve nanodomains and enzyme-induced compositional heterogeneity within membranes, where NR within liquid-ordered vs. liquid-disordered domains shows a ˜4° difference in polar angle and a ˜0.4π sr difference in wobble angle. As a new type of imaging spectroscopy, SMOLM sheds light on the organizational and functional dynamics of lipid-lipid, lipid-protein, and other soft matter assemblies at the single-molecule level with nanoscale resolution.

### Example 5: Comparison of SMOLM Orientation Spectra of Lipophilic Dyes in Lipid Membranes

Nile red (NR), a well-known classic solvatochromic dye for over 30 years,³⁰ is an outstanding “orientation-sensitive” dye for SMOLM, whose orientation spectra are extremely sensitive to the composition and packing of lipid membranes.

Within cell membranes, cholesterol (chol) plays a vital role in ordering and condensing lipid acyl chains, stabilizing lipid membranes, and forming nanoscale membrane domains.^{1,38}

We discovered that the orientation spectra of single Nile red molecules are remarkably sensitive to the composition and packing of lipids influenced by chol. In DPPC without chol, NR exhibits a tilted out-of-plane orientation (θ=23.9±21.8°) and relatively large wobble (Ω=1.69π±0.63π sr). As the chol concentration increases to 40%, both polar and solid angles decrease drastically (θ=8.7±7.6°, Ω=0.51π±0.36π sr, FIG. 1E) with narrower distributions. These data suggest that chol strongly orders and condenses NR within the membrane in addition to the lipids themselves. These ordering effects are strongest for low chol concentrations (0˜20%, FIG. 1E inset).

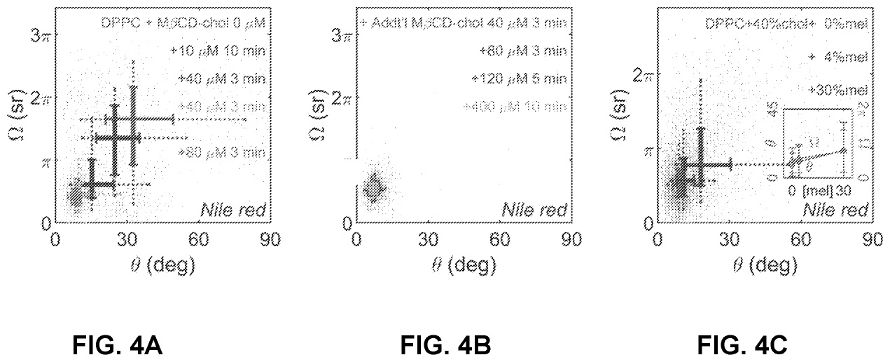

In another experiment, the concentration of cholesterol (chol) in DPPC SLBs was elevated in-situ using cholesterol-loaded methyl-β-cyclodextrin (MDCD-chol). After four successive MβCD-chol treatments, the out-of-plane tilt and wobble of Nile red (NR) decrease to a level (θ=8.4±8.2°, Ω=0.40π±0.27π sr, FIG. 4A) commensurate with 40% chol (FIG. 1E). Repeating treatments with high doses of MβCD-chol has little impact on the orientation spectra, implying that the solubility limit of chol has been reached (FIG. 4B). The tilt and wobble of NR decrease to a level (FIGS. 4A and 4B) commensurate with 40% chol.

As an additional experiment, the effects on the orientation spectra of NR by adding melatonin, which is known to increase the disorder of lipid acyl chains and alleviate cholesterol's effects.³

Our observations of NR's orientational dynamics are remarkably consistent with the “umbrella model” of a lipid bilayer. In this model, the large hydrophilic phosphocholine headgroups form a cover, shielding cholesterol's hydrocarbon steroid rings from the surrounding solvent while its hydroxyl group lies in close proximity to the lipid-water interface. In umbrella model of a lipid bilayer,¹ the large hydrophilic phosphocholine headgroups form a cover to shield the hydrocarbon steroid rings of cholesterol and prevent their exposure to water. Therefore, chol is expected to be positioned in a configuration with its hydroxyl group in close proximity to the lipid-water interface and its hydrocarbon steroid incorporated into the nonpolar interior of the lipid membrane. When Nile red binds to the lipid membrane, it is reported to also occupy the interfacial region of the membrane as chol.² The ordering effect of chol on the lipids within the bilayer, as well as the noncovalent interactions between the planar 4-ring structure of chol and planar benzophenoxazine of Nile red, causes Nile red to align along the orientation of chol. The “alignment” effect is so strong that even with a very small amount of chol (e.g. 5%) present, a dramatic decrease in polar angle of Nile red is observed (FIG. 1E inset, θ curve). Moreover, as chol concentration increases, chol takes more space in the hydrophobic regions under the phospholipid polar headgroup, which reduces the free volume and limits the wobbling movement of Nile red. This “crowding” effect is proportional to the amount of chol added to the lipid membrane, which explains the inverse relationship between solid angle and chol concentration (FIG. 1E inset, Ω curve). Therefore, chol tends to align and condense lipid acyl chains, thereby restricting translational and rotational movements of molecules within the bilayer. Based on our observations, we surmise that NR primarily resides in the non-polar region of the bilayer surrounded by acyl chains. Chol-induced ordering orients NR parallel to neighboring acyl chains and perpendicular to the plane of the bilayer, and chol-induced condensation crowds molecules within the bilayer and thus decreases NR wobbling.

Interestingly, SMOLM reveals that the orientation dynamics of NR are more sensitive to the identity of lipid acyl chains than headgroups. In the presence of 40% chol with increasingly unsaturated lipids (DPPC, POPC, and DOPC, FIG. 1F), NR shows the largest solid (Ω=1.45π±0.41π sr) and polar (θ=15.1±11.8°) angles in disordered DOPC, compared to Ω=0.51π±0.36π sr and 0=8.7±7.6° in ordered DPPC. The disordered acyl chains likely counter chol's ordering effect, thereby increasing the solid and polar angles of embedded fluorescent probes. The ordering effect of chol on NR is weaker in more disordered POPC and DOPC (FIGS. 5A and 5B) as compared to DPPC. In contrast, palmitoyl sphingomyelin (SPM) has the same acyl chains as DPPC but different headgroups. As a result, the orientation spectra of NR within SPM and DPPC are virtually indistinguishable with increasing chol concentration (FIGS. 1E and 5C).

These SMOLM observations provide powerful insight into NR's interactions with lipid structures; NR emits fluorescence while inhabiting the non-polar region of a lipid bilayer, and its rotational dynamics are dictated by the specific environment “underneath the umbrellas,” not within the polar headgroups.

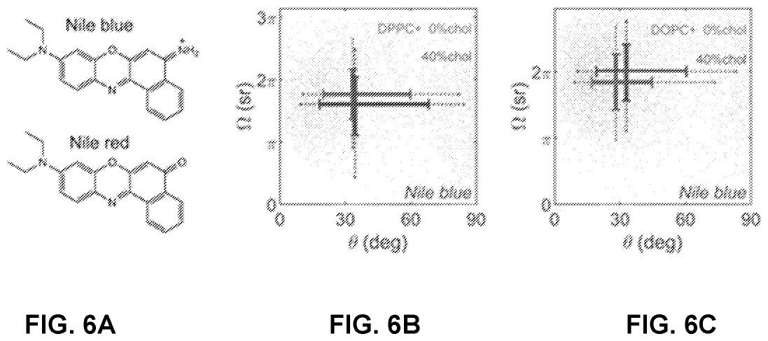

To further characterize the interactions of lipophilic dyes within other regions of lipid bilayers, the following experiments were conducted by performing SMOLM imaging of Nile blue. Nile blue is an analog of Nile red in the benzophenoxazine family (FIG. 6A), and as a cationic dye, it is more likely than Nile red to stay in the polar head region of the lipid bilayer and avoid entering the hydrophobic interior. We observed fewer changes in the orientation spectra of Nile blue (θ<5° and Ω<0.16π sr) in response to various lipid compositions and degrees of packing (FIGS. 6B and 6C) compared to Nile red, which implies that Nile blue is insensitive to chol-induced ordering and condensation of the hydrophobic core of the bilayer. The observation is consistent with our aforementioned mechanistic view of the lipid “umbrella”.

Note that conventional SMLM does not have sufficient spatial resolution in the axial direction (<1 nm) to resolve polar headgroups vs. lipid acyl chains within lipid bilayers. However, SMOLM imaging of NR orientation spectra reveals its precise spatial positioning relative to the substructure of the lipid membrane in addition to yielding information about the chemical environment surrounding each individual NR molecule.

To demonstrate the imaging of lipid phases within lipid membranes, SMLM imaging of Merocyanine 540 (MC540) was conducted. Lipophilic probes that are sensitive to lipid packing enable SMOLM to map compositional and structural heterogeneities within lipid membranes, such as lipid domains. Using points accumulation for imaging in nanoscale topography (PAINT, a form of conventional SMLM), Merocyanine 540 (MC540) is capable of resolving gel (or liquid-ordered, Lo) and liquid (or liquid-disordered, Ld) phases in lipid membrane⁴. This mixture forms liquid-ordered (Lo) and liquid-disordered (Ld) phases as shown in conventional PAINT SMLM, where Lo/Ld domains are revealed by densities of MC540 localizations (FIG. 2A (left), dark: Lo, bright: Ld).

To demonstrate, we carried out SMOLM imaging on a ternary lipid mixture of DOPC/DPPC/chol (35:35:30, molar ratio). Previous studies have found both fluorescent monomers and nonfluorescent dimers of MC540 in lipid membranes. Further, the monomer-dimer equilibrium is sensitive to lipid phase, where the equilibrium dimerization constant for MC540 in the liquid phase (K_{d}=4×10³ M⁻¹) is smaller than that in the gel phase (K_{d}=1.7×10⁵ M⁻¹).⁵⁻⁷ Therefore, in SMLM, the number density of MC540 in gel (or Lo) phases is lower than liquid (or Ld) phases.⁴ Typically, we captured 50,000 MC540 SMLM frames at an average localization density of 0.14 μm⁻² in a GLOX buffer (50 mM Tris, 10 mM NaCl, 10% w/v glucose, 0.5 mg/mL glucose oxidase, 0.05 mg/mL catalase, pH 8.0) used to minimize photobleaching. Regions with dramatically fewer localizations are identified as gel (or Lo) domains, and brighter regions are labeled as liquid (or Ld) domains (FIG. 2A (left) and FIG. 3A); note, however, that the localization threshold for determining the precise identity of these domains has not yet been characterized as a function of buffer, photoexcitation, and fluorescence acquisition conditions. In this work, we only use MC540 for SMLM imaging for distinguishing gel (or Lo) and liquid (or Ld) phases in lipid membrane.

SMOLM imaging, on the other hand, captures sensitive maps of chol concentration and acyl chain structure using the orientation and wobble responses of Nile red (FIG. 2A (left center and right center)). The Lo phases consist of ordered DPPC with high concentrations of chol,^{1,42} which results in small NR solid and polar angles, compared to Ld phases formed by disordered DOPC (FIG. 2C). Since both orientation and wobble carry information useful for resolving Lo vs. Ld domains, we use principal component analysis (PCA, Methods) to combine the polar and solid angle data into a scalar “phase-index” map that discriminates Lo (phase indices <−0.28 arb. units) and Ld domains (FIG. 2A (right)).

SMOLM imaging shows Lo domains of various sizes both above (˜500 nm) and below (<200 nm) the diffraction limit (green regions 1 and 2 in FIG. 2B). In large Lo domains, the cross-sectional profile of phase index (small values) matches well with the SMLM data (regions containing few localizations, FIG. 2D (left)). However, local spikes (bins with dramatically more numerous localizations) in the SMLM image imply the existence of small (˜47×47 nm²) Ld regions located within Lo domains (FIG. 2D (left), marked by an asterisk). Close examination of corresponding raw SMLM images shows that these bright regions are generated by MC540 molecules with long binding times and confined lateral diffusion. They always appear in successive frames at fixed locations, which is quite different from diffusing MC540 molecules in nearby Ld domains. Apparently, these bright regions in the SMLM image still belong to the Lo phase, even though the localization density is comparable to those in Ld phases. Therefore, SMLM imaging is particularly susceptible to contrast fluctuations from stochastic probe binding times. On the other hand, SMOLM measures the orientation spectra of every probe molecule independent of the probe's binding time to the membrane and is therefore more robust to nonuniform localization densities over different lipid phases. SMOLM also shows good performance for resolving Lo domains below the diffraction limit (green region 2 in FIG. 2B). The cross-sectional profile of phase index within these small Lo domains is nosier but still consistent with the SMLM profile (FIG. 2D (right)).

One advantage of SMOLM is that lipid composition and packing information are inferred from orientation measurements, which are collected simultaneously with molecule positions. If the position and orientation of each molecule are accurately estimated, only one orientation measurement is required to distinguish Lo and Ld phases in a given pixel. In SMOLM, as long as the position and orientation of each molecule are accurately estimated, only one molecule, or one orientation measurement, is required in each bin to distinguish Lo and Ld domains from one another. For a given localization density, SMOLM reconstructs lipid domains and resolves their structure more robustly compared to SMLM.

To demonstrate, we use the data from the lipid mixture of DOPC/DPPC/chol (35:35:30, molar ratio) containing both Lo and Ld domains in FIG. 2A in the main text. We randomly selected different subsets of localizations from the entire dataset and reconstructed the SMLM images and SMOLM maps. Each subset contains localizations corresponding to densities of 50, 100, 400, and 900 molecules/μm² (mol./μm²). To guarantee the estimated position and orientation of the selected localizations are accurate, we only choose the localizations with the brightness higher than the third quartile of the entire population, i.e., the best localizations in both SMLM and SMOLM. For SMOLM data, the median value of phase index from each selected subset is the same as the entire population to avoid a biased selection of localizations from Lo or Ld phases.

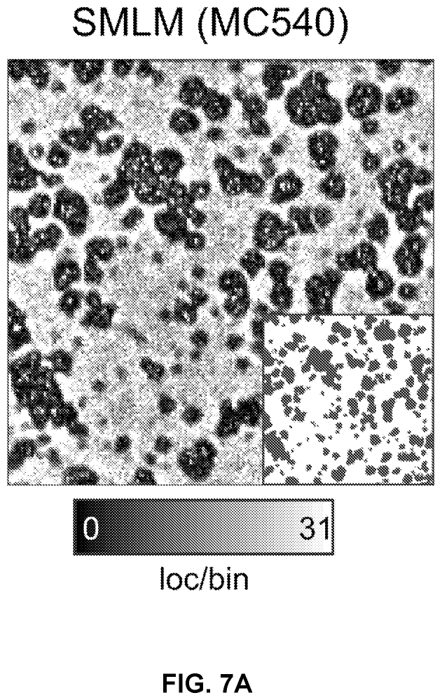

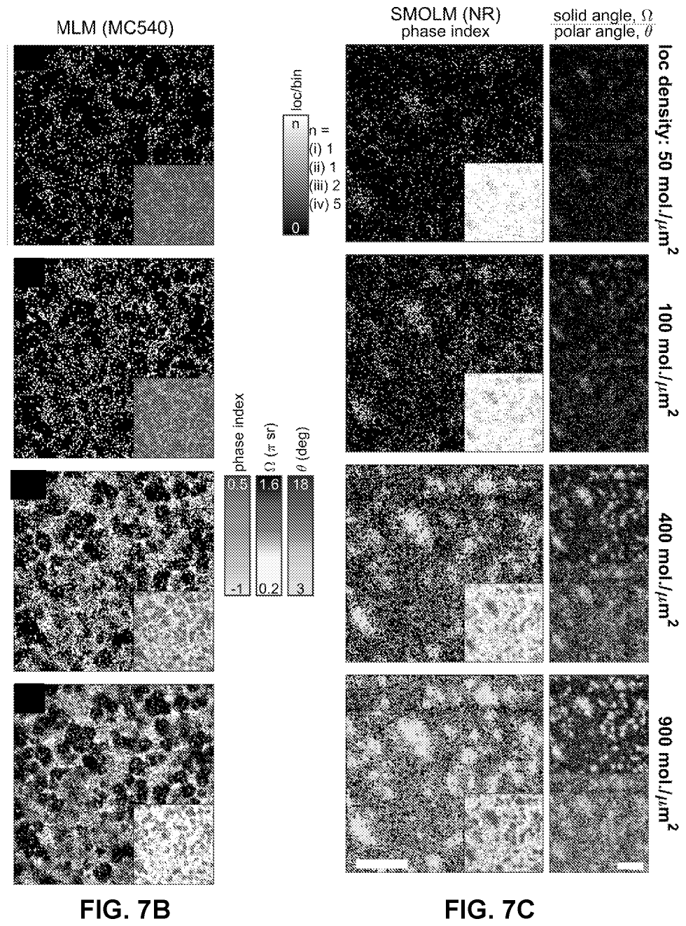

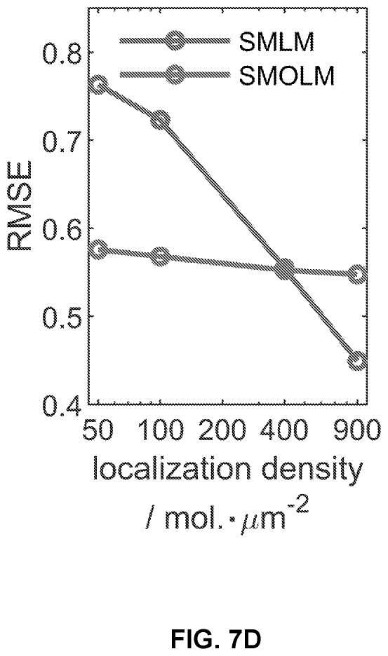

The MC540 SMLM image (FIG. 7A) with high localization density (9×103 mol./μm2) was used as the ground truth image to show the location, size, and shape of Lo and Ld domains. For low localization density (i.e. 50 mol./μm2), the SMLM image (FIG. 7B (top)) has very limited resolution to reveal Lo domains. The corresponding phase-index map (FIG. 7C (top)) in the SMOLM image, however, already shows the locations of major Lo domains. As the localization density increases (100 to 900 mol./μm2), both the SMLM images (FIG. 7B (rows 2, 3, and 4)) and SMOLM maps (FIG. 7C (rows 2, 3, and 4)) show improved contrast between the Lo and Ld domains.

To quantify the performance of SMOLM and SMLM to resolve the Lo/Ld phases, we measure the image similarity between the SMOLM or SMLM images under various localization densities and the ground truth image. First, we created binary Lo domain maps from SMOLM or SMLM data to illustrate the Lo/Ld domains. For a lipid mixture containing gel (or Lo) and liquid (or Ld) phases, we performed principal component analysis (PCA) on SMOLM datasets containing orientation (polar angle θ) and wobble (solid angle Ω) measurements. The data of θ and Ω were first standardized by removing the mean and scaling to unit variance, and subsequently, PCA was applied to reduce the dimensionality.²² We designated the resulting PCA scores (first component) as the phase index for generating SMOLM phase-index maps (FIGS. 2, 7, and 8).

Gel (or Lo) and liquid (or Ld) phases can be discriminated by using the localization density (per pixel) in SMLM. For example, in the lipid mixture of DOPC/DPPC/chol in FIG. 2B, regions with fewer than 4 localizations/bin in the SMLM image are assigned as the Lo phase, and regions with counts above 4 per pixel are designated as the Ld phase. Using these classifications as a ground-truth calibration for our phase-index values (arb. units), we compute the distribution of phase index in each phase (Lo: −0.63±0.91, Ld: 0.06±1.02), and set the midpoint between the mean indices (−0.28, arb. units) as the threshold to separate Lo and Ld domains.

Regions in the SMLM image with fewer than 1 localization per bin, in the SMOLM image with phase index smaller than −0.28 (arb. Units), and in the ground truth SMLM image with fewer than 10 localizations per bin were designated as the Lo phase (blue regions in insets of FIGS. 7A, 7B, and 7C). Next, for each scenario with a given localization density (50 to 900 mol./μm²), we calculated the Root Mean Squared Error (RMSE) between the binary Lo domain map from the ground truth image (inset of FIG. 7A) and the binary Lo domain map from SMOLM (insets of FIG. 7c) or SMLM (insets of FIG. 7B). As shown in FIG. 7D, RMSE_{SMOLM} is smaller than RMSE_{SMLM} below a localization density of 400 mol./μm². RMSE_{SMLM} quickly drops as localization density increases and is lower than RMSE_{SMOLM} at the localization density of 900 mol./μm². Note that since we designated the SMLM image as the ground-truth image in this analysis, we expect RMSE_{SMLM} to outperform RMSE_{SMOLM} at some threshold localization density, which is not an indicator of the true accuracy of discriminating Lo vs. Ld domains. In the future, the true RMSE performance can be determined by correlating against a secondary imaging modality.

Therefore, for a given total localization number, especially for low localization density, our data indicate that the SMOLM map exhibits better performance to distinguish Lo and Ld domains than conventional lipid membrane SMLM imaging via PAINT.

It has long been observed, using fluorescence polarization imaging of giant vesicles, that NR, Laurdan, and 3-hydroxyflavone derivatives exhibit preferentially perpendicular orientations relative to the membrane surface in Lo phases due to constrained lipid packing and no preferential orientation in loosely packed Ld phases.21-23 Our SMOLM images provide the first quantitative measurements of this phenomena at the SM level and confirm that both polar angle and wobbling are increased in the Ld phase (0=8.7±7.6°, Ω=0.511±0.36π sr for NR in DPPC+40% chol [Lo phase] vs. 0=17.4±15.1°, Ω=1.43π±0.50π sr for NR in DOPC [Ld phase]). Leveraging this effect, SMOLM images, and their associated phase-index maps, can be used to discriminate between types of lipid domains. Compared to SMLM, SMOLM requires fewer total localizations and is less affected by localization density fluctuations when used for classifying Lo and Ld domains. Furthermore, SMOLM is the first fluorescence imaging approach that reveals the formation of a ceramide-enriched phase within single Lo domains (FIG. 3), which previously could only be observed by AFM imaging. In the future, SMOLM can be extended to visualize a variety of membrane-biomolecule interactions that will shed light on how the composition and structure of the membrane affect biological function.

### Example 6: SMOLM Imaging of Enzyme-Mediated Changes to Lipid Composition

Since SMOLM is able to quantify lipid composition and phase in a static SLB, we next extend SMOLM to monitor enzyme activity within lipid membranes in situ. In the plasma membrane, sphingomyelin (SPM) is the main sphingolipid component that forms cholesterol-rich domains. The hydrolysis of SPM via sphingomyelinase (SMase) generates a bioactive lipid, ceramide, which selectively displaces chol from Lo domains at a 1:1 molar ratio,⁴³ promotes lipid phase reorganization, forms a ceramide-rich ordered phase,⁴⁴ and impacts cellular signaling and other vital processes.⁴⁵ Most of these nanoscopic structural details were first observed by atomic force microscopy (AFM)⁴⁴, which however is mostly limited to planar and static lipid samples and often requires complementary fluorescence imaging for visualizing lipid dynamics on faster timescales.^{46,47}

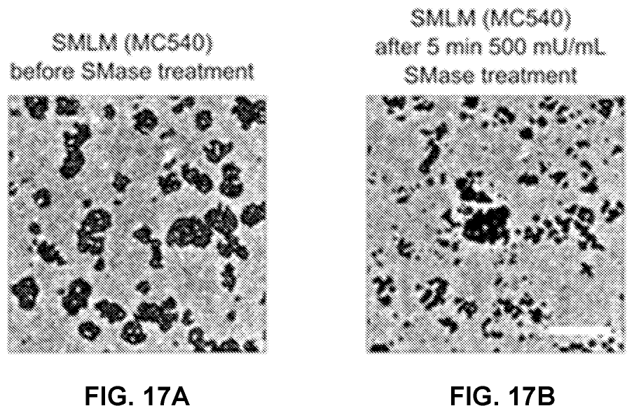

Conventional SMLM imaging shows that SMase causes extensive changes in the morphology of ordered domains in DOPC/SPM/chol. With high doses of SMase (500 mU/mL) applied to DOPC/SPM/chol (35:35:30, molar ratio) SLBs, we observed extensive changes in the morphologies of Lo domains (dark regions in FIGS. 17A and 17B) due to the enzymatic generation of ceramide. The total Lo domain size reduces from 32.2 μm² (FIG. 17A) to 15.9 μm² (FIG. 17B). On average, the total Lo domain area decreases by 50%, which is mainly caused by tightly packed ceramide that decreases the distance between the lipid molecules via extensive hydrogen bonding. The tightly packed ceramide molecules reduce Lo domain sizes by 50%. However, for low SMase concentrations, the size and shape of the Lo domains are mostly conserved, and therefore, limited information on enzyme activity can be obtained from conventional SMLM imaging. We instead applied SMOLM to monitor the underlying lipid compositional changes and resolve the spatial redistribution of newly generated ceramide and displaced chol within individual Lo domains.

We next conducted SMOLM imaging of mixed DOPC/SPM/chol bilayers (35:35:30, molar ratio) with successive SMase treatments of increasing dosage. Low SMase doses were chosen to test SMOLM sensitivity for detecting subtle enzyme activity within Lo domains (FIG. 3A, SMLM images at t₀,t₃).

The SMOLM maps (FIG. 3B) indicate a dose-dependent disappearance of chol-rich Lo domains. Before treatment (t₀), the shapes and positions of chol-rich Lo domains (small polar angle, solid angle, and phase index) imaged by SMOLM match the Lo domains mapped by SMLM. SMase treatment (16 mU/mL) induced insignificant changes in the SMOLM maps (FIG. 3B, t₁), while more regions within the Lo domains begin to lose their chol-rich signature at a larger dose (50 mU/mL SMase, t₂). After a 250 mU/mL dose of SMase, almost all the chol-rich Lo domains disappeared (FIG. 3B, t₃); however, conventional SMLM only reveals very minor changes in the size and shape of Lo domains (FIG. 3A, t₃). The changes in orientation spectra agree well with those of NR within SPM+chol and SPM+cer single-phase lipid samples and strongly indicate the generation of cer-rich, chol-poor Lo domains (FIG. 16B, Table 1).

To study the spatial organization and compositional changes in further detail, we focus our analysis on one particular Lo domain (red box in FIGS. 3A and 3B). The boundary of the Lo domain before (solid black line in FIG. 3C) and after (dotted black line in FIG. 3C) SMase treatment was determined by the SMLM images at to and t₃. At a dose of 50 mU/mL (t₂), the phase indices in several regions increase (arrows in FIG. 3C, t₂), indicating that these Lo regions are beginning to lose chol. This process is always localized in the interior of the domain (arrow 1 in FIG. 3C, t₂ or at the intersection of two domains (arrow 2 in FIG. 3C, t₂), which agrees with previous nanoscopic AFM observations. As the dose of SMase increases to 250 mU/mL (FIG. 3C, t₃), the chol-rich phase continues to shrink and is replaced by ceramide-rich domains. The compositional transition from chol-rich to ceramide-rich within this domain is also clearly illustrated by the change in orientation spectra from t₀ to t₃ (FIG. 3D).

To clearly visualize the lipid composition distribution, we designate the region outside of the domain boundary as the Ld phase and use the phase index of −0.014 (arb. Units) as a threshold to separate the chol-rich phase from the ceramide-rich phase (FIG. 3C, right)). Besides the Lo domains that maintain shape after SMase treatment, we also identified newly formed Lo domains (orange box in FIGS. 3A and 3B) in locations where DOPC Ld phases originally resided (FIG. 3E, to). Interestingly, SMOLM imaging indicates these domains are composed of well-separated chol-rich and ceramide-rich phases (FIG. 3E, center and right). The lipid composition maps among different Lo domains (FIGS. 3C and 3E) reveal spatially heterogeneous nanoscale SMase activity, and also suggest that both SMase-generated ceramide and ceramide-displaced cholesterol rapidly (˜seconds-minutes) condense into respectively enriched Lo domains after SMase treatment. The activity of SMase (conversion of SPM to ceramide) varies among different Lo domains. Analysis on multiple single Lo domains (FIG. 20A) reveals both nearly complete conversion (FIG. 20B (i) and (ii)) and partial conversion (FIG. 20B (iii) and (iv)) to cer-rich SPM phases. There also exist newly formed Lo domains (FIG. 20B (v)) containing well-separated chol-rich and cer-rich phases.

What is claimed is:

1-25. (canceled)

26. A phase mask for a point spread function imaging system, the phase mask comprising at least three partitions, each partition comprising a phase delay ramp aligned along one of two phase delay axes, each phase delay ramp comprising a gradient of phase delays, wherein: each partition comprises a subset of a total area of the phase mask and the two phase delay axes are oriented in different directions.

27. The phase mask of claim 26, wherein the phase mask is configured to produce a duo-spot point-spread function comprising two light spots wherein each light spot corresponds to one phase delay axis of the two phase delay axes.

28. The phase mask of claim 27, wherein the phase mask is configured to produce the duo-spot point-spread function in response to photons produced by a single point emitter.

29. The phase mask of claim 27, wherein a relative brightness of each spot of the duo-spot point spread function encodes an orientation and a rotational mobility of the single point emitter.

30. The phase mask of claim 26, wherein the two phase delay axes are oriented parallel and in opposite directions to one another.

31. The phase mask of claim 26, wherein the shape of each partition is configured to separate one basis image from a plurality of base images consisting of Bₓₓ, B_{yy}, B_{zz}, B_{xy}, B_{yz}, and B_{xz}, the one basis image selected from Bₓₓ, B_{yy}, and B_{zz} within an x-polarized image channel and a y-polarized image channel of the point spread function imaging system.

32. A point spread function imaging system, comprising:
a source arranged and configured to output an excitation beam that is directed to a sample containing at least one emitter that emits a dipole or dipole-like radiation pattern when illuminated by the excitation beam;
at least one sensor arranged and configured to capture at least one image of at least a portion of a radiation pattern emitted by the at least one emitter in response to impingement by the excitation beam; and
a phase mask positioned between the at least one emitter and the at least one sensor, the phase mask configured to produce a duo-spot point spread function in response to photons received from the at least one emitter, wherein the duo-spot point spread function is received by the at least one sensor.

33. The system of claim 32, wherein the phase mask comprises at least three partitions, each partition comprising a phase delay ramp aligned along one of two phase delay axes, each phase delay ramp comprising a gradient of phase delays, wherein each partition comprises a subset of a total area of the phase mask and the two phase delay axes are oriented in different directions.

34. The system of claim 33, wherein the duo-spot point-spread function comprises two light spots, wherein each light spot corresponds to one phase delay axis of the two phase delay axes.

35. The system of claim 32, wherein the phase mask is configured to produce the duo-spot point-spread function in response to photons produced by one of the at least one emitters.

36. The system of claim 34, wherein a relative brightness of each spot of the duo-spot point spread function encodes an orientation and a rotational mobility of one of at least one emitters.

37. The system of claim 33, wherein the two phase delay axes are oriented parallel and in opposite directions to one another.

38. The system of claim 32, wherein the phase mask further comprises a phase-only spatial light modulator.

39. The system of claim 33, wherein the shape of each partition is configured to separate positive and negative energies associated with one basis image from a plurality of base images consisting of Bₓₓ, B_{yy}, B_{zz}, B_{xy}, B_{yz}, and B_{xz} within an x-polarized image channel and a y-polarized image channel of the point spread function imaging system, wherein the one basis image is selected from Bₓₓ, B_{yy}, and B_{zz}.

40. The system of claim 33, wherein the shape of each partition is configured to separate positive and negative energies associated with one basis image from a plurality of base images consisting of Bₓₓ, B_{yy}, B_{zz}, B_{xy}, B_{yz}, and B_{xz} within an x-polarized image channel and a y-polarized image channel of the point spread function imaging system, wherein the one basis image is selected from B_{xy}, B_{yz}, and B_{xz}.

41. The system of claim 36, further comprising a computing device operatively connected to the sensor, the computing device configured to estimate the orientation and the rotational mobility of the at least one emitter encoded by the spots of the duo-spot point-spread function using a method selected from a basis inversion method, a maximum likelihood estimation method, and any combination thereof.

42. A method for estimating an orientation and a rotational mobility of a single-molecule emitter, comprising:
receiving a plurality of photons emitted by the single-molecule emitter to produce a back focal plane intensity distribution;
modifying the back focal plane intensity distribution using a phase mask to produce an image plane intensity distribution, the image plane intensity distribution comprising a duo-spot point spread function, the duo-spot point spread function comprising two light spots; and
estimating the orientation and rotational mobility of the dipole-like emitter based on a relative brightness of the two light spots of the duo-spot point spread function.

43. The method of claim 42, wherein the phase mask comprises at least three partitions, each partition comprising a phase delay ramp aligned along one of two phase delay axes, each phase delay ramp comprising a gradient of phase delays, wherein:
each partition comprises a subset of a total area of the phase mask and the two phase delay axes are oriented in different directions.

44. The method of claim 42, wherein the orientation and the rotational mobility of the single-molecule emitter are estimated using a method selected from a basis inversion method, a maximum likelihood estimation method, and any combination thereof.

45. The method of claim 42, further comprising separating the back focal plane intensity distribution into a first channel comprising a first light polarization and a second channel comprising a second light polarization and modifying the first channel and the second channel independently using the phase mask to produce a first and second channel of the image plane intensity distribution.
